(19) United States
(12) Patent Application Publication
(10) Pub. No.: US 2021/0155827 A1
(43) Pub. Date: May 27, 2021

(54) PROCESS FOR PRODUCING A SELF-ADHESIVE COMPOSITION LAYER FOAMED WITH MICROBALLOONS

(71) Applicant: TESA SE, Norderstedt (DE)

(72) Inventors: Anna BLAZEJEWSKI, Hamburg (DE); Axel BURMEISTER, Hamburg (DE); Franciska LOHMANN, Hamburg (DE); Anika PETERSEN, Heidmühlen (DE); Ingrid BENDEICH, Hamburg (DE)

(73) Assignee: TESA SE, Norderstedt (DE)

(21) Appl. No.: 17/053,994

(22) PCT Filed: May 3, 2019
(86) PCT No.: PCT/EP2019/061405

§ 371 Date: Nov. 9, 2020

(30) Foreign Application Priority Data
May 8, 2018 (DE) 10 2018 207 149.7
May 8, 2018 (EP) 18171236.5

(51) Int. Cl. C09J 7/29; C08K 9/10; C09J 7/35; C09J 7/38; C09J 7/40; B32B 7/12; B32B 7/06; B32B 5/18

(52) U.S. Cl. CPC C09J 7/29; B32B 2405/00; C09J 7/35; C09J 7/385; C09J 7/387; C09J 7/401; B32B 7/12; B32B 7/06; B32B 5/18; C09J 2203/33; C09J 2301/312; C09J 2301/412; C09J 2400/24; B32B 2266/0228; B32B 2266/0242; C08K 9/10

(57) ABSTRACT

The present invention relates to a method for producing a layer of self-adhesive composition at least partially foamed with microballoons, wherein a foamable layer of self-adhesive composition comprising expandable microballoons and disposed between
(i) two liners,
(ii) a liner and a carrier, or
(iii) a liner and a further layer of self-adhesive composition which (a) is not foamable or (b) is foamable and typically comprises expandable microballoons,
   is heat-treated at a temperature suitable for foaming for a period such that after the subsequent cooling of the layer the desired degree of foaming is attained, characterized in that
   the two liners or the liner during the foaming remain or remains adhering substantially completely on the respective surface of the foamable layer of self-adhesive composition on which they or it are or is disposed.

The invention relates to a method for producing a layer of self-adhesive composition at least partially foamed with microballoons. It further relates to an adhesive tape which comprises at least one layer of self-adhesive composition obtainable by such a method. It additionally relates to the use of such an adhesive tape for bonding components such as, in particular, rechargeable batteries and electronic devices such as, in particular, mobile devices, such as mobile phones, for example.

Adhesive tapes are frequently used for the bonding of very small components in devices in the consumer electronics industry for example. For this to be made possible it is necessary that the shape of the adhesive tape section is adapted to the shape of the component. Among the geometries required in this case are often difficult geometries, which are obtained by diecutting the adhesive tape. Accordingly, border widths in diecut parts of a few millimetres or even less are by no means uncommon. The application of these sensitive adhesive tapes to the components is frequently attended by deformation of the diecut parts.

In order to prevent or at least reduce the deformation, it has emerged as advantageous to integrate a film, for example a PET film, as a middle ply into the adhesive tapes in order to accommodate the tensile forces experienced during application.

Adhesive bonds with adhesive tapes of these kinds are increasingly also being used when the component is subject to shock loads. Adhesive bonds having proven particularly shock-resistant are those with pressure-sensitive adhesive strips which comprise a viscoelastic, syntactically foamed core, a stabilizing film and, on the outer plies, two self-adhesive layers.

These pressure-sensitive adhesive strips are effective in that under shock loading a cohesive fracture is observed within the strip. The bond between the foamed core and the stabilizing film fails, and foam and film part from one another.

Foamed pressure-sensitive adhesive systems have been known for some considerable time and are described in the prior art.

In principle there are two ways in which polymer foams can be produced. One involves the action of a blowing gas, either added as such or resulting from a chemical reaction; the other involves the incorporation into the material matrix of hollow spheres. Foams produced in the latter way are referred to as syntactic foams.

With a syntactic foam, hollow spheres such as glass spheres or hollow ceramic spheres (microspheres) or microballoons are incorporated in a polymer matrix. As a result, in the case of a syntactic foam, the voids are separate from one another, and the substances (gas, air) present in the voids are separated by a membrane from the surrounding matrix.

Compositions foamed with hollow microspheres are distinguished by a defined cell structure with a uniform size distribution of the foam cells. With hollow microspheres, closed-cell foams without cavities are obtained, which in comparison to open-cell versions are distinguished by features including more effective sealing with respect to dust and liquid media. Furthermore, materials foamed chemically or physically are more susceptible to irreversible collapse under pressure and temperature, and frequently exhibit a lower cohesive strength.

Particularly advantageous properties can be achieved if the microspheres used for foaming comprise expandable microspheres (also referred to as “microballoons”). By virtue of their flexible, thermoplastic polymer shell, foams of this kind possess a greater conformabiliity than those filled with non-expandable, non-polymeric hollow microspheres (hollow glass spheres, for example). They are suitable more effectively for compensating manufacturing tolerances, of the kind which are the rule in the case of injection-moulded parts, for example, and on the basis of their foam character they are also better able to compensate thermal stresses.

Furthermore, through the selection of the thermoplastic resin of the polymer shell, it is possible to exert further influence over the mechanical properties of the foam. Hence it is possible for example to produce foams having greater cohesive strength than with the polymer matrix alone, even if the foam has a lower density than the matrix. Hence typical foam properties such as the conformability to rough substrates can be combined with a high cohesive strength for self-adhesive foams.

The devices in the consumer electronics industry include electronic, optical and precision-mechanical devices, for the purposes of this specification, more particularly devices as classified in Class 9 of the International Classification of Goods and Services for the Registration of Marks (Nice Classification), 10th edition (NCL(10-2013)), to the extent that they are electronic, optical or precision-mechanical devices, and also clocks and chronometers according to Class 14 (NCL(10-2013)), such as, in particular
scientific, marine, measurement, photographic, film, optical, weighing, measuring, signalling, monitoring, rescuing, and instruction apparatus and instruments;
apparatus and instruments for conducting, switching, transforming, storing, regulating, and monitoring electricity;
image recording, processing, transmission, and reproduction devices, such as televisions and the like, for example
acoustic recording, processing, transmission, and reproduction devices, such as broadcasting devices and the like, for example
computers, calculating instruments and data-processing devices, mathematical devices and instruments, computer accessories, office instruments—for example, printers, faxes, copiers, word processors—, data storage devices
telecommunications devices and multifunctional devices with a telecommunications function, such as telephones and answering machines, for example
chemical and physical measuring devices, control devices, and instruments, such as battery chargers, multimeters, lamps, and tachometers
nautical devices and instruments
optical devices and instruments
medical devices and instruments and those for sports people
clocks and chronometers
solar cell modules, such as electrochemical dye solar cells, organic solar cells, thin-film cells,
fire-extinguishing equipment.

Technical development is going increasingly in the direction of devices which are ever smaller and lighter in design, allowing them to be carried at all times by their owner, and usually being generally carried. This is typically accomplished by realization of low weights and/or suitable size of such devices. Such devices are also referred to as mobile devices or portable devices for the purposes of this specification. In this development trend, precision-mechanical and optical devices are increasingly being provided (also) with electronic components, thereby raising the possibilities for minimization. On account of the carrying of the mobile devices, they are subject to increased loads—especially mechanical loads—for instance by impact on edges, by being dropped, by contact with other hard objects in a bag, or else simply by the permanent motion involved in being carried per se. Mobile devices, however, are also subject to a greater extent to loads due to moisture exposure, temperature effects, and the like, as compared with those “immobile” devices which are usually installed in interiors and which move little or not at all.

The invention refers accordingly with particular preference to mobile devices, since the pressure-sensitive adhesive strip used in accordance with the invention has a particular benefit here on account of its unexpectedly good—that is, further improved—properties (very high shock resistance). Listed below are a number of portable devices, without wishing the representatives specifically identified in this list to impose any unnecessary restriction on the subject matter of the invention.
Cameras, digital cameras, photographic accessories (such as light meters, flashguns, diaphragms, camera casings, lenses, etc.), film cameras, video cameras,
small computers (mobile computers, pocket computers, pocket calculators), laptops, notebook computers, netbooks, ultrabooks, tablet computers, handhelds, electronic diaries and organizers (called “Electronic Organizers” or “Personal Digital Assistants”, PDAs, palmtops), modems,
computer accessories and operating units for electronic devices, such as mice, drawing pads, graphics tablets, microphones, loudspeakers, games consoles, game pads, remote controls, remote operating devices, touchpads,
monitors, displays, screens, touch-sensitive screens (sensor screens, touchscreen devices), projectors
readers for electronic books (e-books),
mini-TVs, pocket TVs, devices for playing films, video players,
radios (including mini and pocket radios), Walkmans, Discmans, music players for e.g. CDs, DVDs, Blu-rays, cassettes, USB, MP3, headphones,
cordless telephones, mobile phones, smartphones, two-way radios, hands-free devices, devices for summoning people (pagers, beepers)
mobile defibrillators, blood sugar meters, blood pressure monitors, step counters, pulse meters
torches, laser pointers
mobile detectors, optical magnifiers, long-range vision devices, night vision devices,
GPS devices, navigation devices, portable interface devices for satellite communications
data storage devices (USB sticks, external hard drives, memory cards)
wristwatches, digital watches, pocket watches, chain watches, stopwatches.

For these devices there is a requirement in particular for adhesive tapes possessing high holding power.

It is important, moreover, that the adhesive tapes do not fail in their holding power if the mobile device—a mobile phone, for example—is dropped and hits the floor. The adhesive strip is required, then, to exhibit very high shock resistance.

EP 2 832 780 A1 relates to a pressure-sensitive adhesive foam comprising a rubber elastomer, at least one hydrocarbon tackifier and a crosslinker selected from the group of the polyfunctional (meth)acrylate compounds.

JP 2010/070,655 A relates to a composition comprising a styrene-based thermoplastic elastomer (A), a tackifier (B) and thermally expandable foaming agent in microcapsule form.

DE 10 2008 056 980 A1 relates to a self-adhesive composition consisting of a mixture comprising:
a polymer blend composed of thermoplastic and/or non-thermoplastic elastomers, with at least one vinylaromatic block copolymer containing a fraction of more than 30 wt % of 1,2-linked diene in the elastomer block,
at least one tackifying resin
expanded polymeric microspheres.

WO 2009/090119 A1 relates to a pressure-sensitive adhesive composition comprising expanded microballoons, where the peel adhesion of the adhesive composition comprising the expanded microballoons is reduced by not more than 30% in comparison to the peel adhesion of an adhesive composition of identical formulation and identical weight per unit area that has been defoamed by the destruction of the voids formed by the expanded microballoons.

WO 2003/011954 A1 relates to a foamed pressure-sensitive adhesive article, the article comprising a) a polymer mixture comprising at least one styrenic block copolymer and at least one polyarylene oxide, and b) one or more foamable polymer microbeads.

WO 00/006637 A1 relates to an article comprising a polymer foam having a substantially smooth surface with an Rₐ value of less than about 75 μm, the foam comprising a multiplicity of microspheres of which at least one is an expandable polymeric microsphere.

WO 2010/147888 A2 relates to a foam comprising a polymer, a plurality of at least partially expanded expandable polymer microspheres, and 0.3 to 1.5 wt % of a silicon dioxide having a surface area of at least 300 square metres per gram in accordance with ASTM D1993-03 (2008).

DE 10 2015 206 076 A1 relates to a pressure-sensitive adhesive strip which can be detached again without residue or destruction through extensive stretching substantially in the plane of the bond, comprising one or more layers of adhesive all consisting of a pressure-sensitive adhesive foamed with microballoons, and optionally of one or more intermediate carrier layers, characterized in that the pressure-sensitive adhesive strip consists exclusively of the stated layers of adhesive and intermediate carrier layers present optionally, and one outer upper face and one outer lower face of the pressure-sensitive adhesive strip are formed by the stated layer or layers of adhesive. The redetachable pressure-sensitive adhesive strip is notable for its pronounced shock resistance.

DE 10 2016 202 479 A1 describes a four-layer adhesive tape wherein a foamed internal layer is additionally strengthened by a PET stabilizing film. By virtue of such a construction, it was possible to offer particularly shock-resistant adhesive tapes.

DE 10 2016 209 707 A1 describes a pressure-sensitive adhesive strip composed of three layers, comprising an inner layer F made of a non-extensible film carrier, a layer SK1 composed of a self-adhesive composition disposed on one of the surfaces of the film carrier layer F and based on a foamed acrylate composition,

and a layer SK2 composed of a self-adhesive composition, which is disposed on the surface of the film carrier layer F opposite from the layer SK1 and is based on a foamed acrylate composition. By means of such a construction it was likewise possible to offer particularly shock-resistant adhesive tapes.

DE 10 2016 207 822 A1 relates to a self-adhesive composition consisting of a mixture comprising rubber, more particularly natural rubber, at least one tackifying resin, the fraction of the tackifying resins being 40 to 130 phr, and expanded polymeric microspheres. The density of the self-adhesive composition is lower than that of customary adhesives, and it exhibits sufficient peel adhesion, is typically redetachable without residue, and displays an improvement in flame retardancy.

The as yet unpublished EP 17 182 443 from the same applicant as this specification concerns a pressure-sensitive adhesive strip composed of at least three layers, comprising an inner layer F made of a non-extensible film carrier, a layer SK1 made of a self-adhesive composition and disposed on one of the surfaces of the film carrier layer F, and based on a vinylaromatic block copolymer composition foamed with microballoons, and a layer SK2 made of a self-adhesive composition, which is disposed on the surface of the film carrier layer F opposite from the layer SK1 and is based on a vinylaromatic block copolymer composition foamed with microballoons, where the average diameter of the voids formed by the microballoons in the layers SK1 and SK2 of self-adhesive composition, in each case independently of one another, is 20 to 60 μm. The pressure-sensitive adhesive strip possesses high shock resistance.

The likewise as yet unpublished EP 17 182 447 from the same applicant as this specification relates to a pressure-sensitive adhesive strip which comprises at least one layer SK1 made of a self-adhesive composition and based on a vinylaromatic block copolymer composition foamed with microballoons, where the average diameter of the voids formed by the microballoons in the layer SK1 of self-adhesive composition is 45 to 110 μm. The pressure-sensitive adhesive strip possesses, in particular, improved thermal shear strength.

The likewise as yet unpublished DE 10 2018 200 957 from the same applicant as this specification relates to a pressure-sensitive adhesive strip which comprises at least one layer SK1 of a self-adhesive composition partially foamed with microballoons, the degree of foaming of the layer SK1 being at least 20% and less than 100%; to a method for producing it; and to the use thereof for bonding components such as, in particular, rechargeable batteries and electronic devices such as, in particular, mobile devices. The pressure-sensitive adhesive strip possesses high shock resistance.

The following two specifications describe methods capable of producing suitable foamed pressure-sensitive adhesive strips.

WO 2009/090119 A1 relates to a pressure-sensitive adhesive which comprises expanded microballoons, where the peel adhesion of the adhesive comprising the expanded microballoons is reduced by not more than 30% by comparison with the peel adhesion of an adhesive of identical formulation and identical weight per unit area that has been defoamed by the destruction of the voids resulting from the expanded microballoons. In this case an at least partially foamed pressure-sensitive adhesive is shaped, between two liners, by means of at least two rolls. The high pressure in the roll nib presses the microballoons breaking through the surface back into the polymer matrix, to form a smooth surface without disruptive microballoons that have broken through.

WO 00/006637 A1 relates to an article comprising a polymer foam having a substantially smooth surface with an Rₐ value of less than about 75 μm, the foam comprising a multiplicity of microspheres of which at least one is an expandable polymeric microsphere. This specification teaches the expansion of the microballoons in the die gap of an extrusion die. The high pressure in the die is utilized here in order to press the expanding microballoons into the polymer matrix.

Both methods are suitable exclusively for solvent-free self-adhesive compositions.

It is an object of the present invention, relative to the prior art, to provide a method for producing a foamed layer of self-adhesive composition, typically from solution, wherein the foaming operation can take place under atmospheric pressure, the intention being that the foamed layer of self-adhesive composition should have a high shock resistance.

The object is surprisingly achieved by a method as described in the main claim, claim 1. Advantageous embodiments of the method are found in the dependent claims.

The invention relates accordingly to a method for producing a layer of self-adhesive composition at least partially foamed with microballoons, wherein a foamable layer of self-adhesive composition comprising expandable microballoons and disposed between
(i) two liners,
(ii) a liner and a carrier, or
(iii) a liner and a further layer of self-adhesive composition which (a) is not foamable or (b) is foamable and typically comprises expandable microballoons,
   is heat-treated by suitable energy input at a temperature suitable for foaming for a period such that after the subsequent cooling of the layer the desired degree of foaming is attained,
   characterized in that
   the two liners or the liner during the foaming remain or remains adhering substantially completely on the respective surface of the foamable layer of self-adhesive composition on which they or it are or is disposed.

The method of the invention therefore produces an at least partially foamed layer of self-adhesive composition possessing improved shock resistance in relation to a layer of self-adhesive composition produced by a prior-art method. Typically, the at least partially foamed layer of self-adhesive composition has a surface roughness Rₐ of less than 3 μm, preferably of less than 2 μm, and more particularly of less than 1 μm. In the present application, Rₐ is measured by means of laser triangulation. A particular advantage of low surface roughnesses is the improved shock resistance of the pressure-sensitive adhesive strip. Furthermore, typically improved peel adhesions are obtained.

The present invention relates further to an adhesive tape which comprises at least one layer of self-adhesive composition at least partially foamed with microballoons and obtainable by such a method.

The present invention relates, moreover, to the use of an adhesive tape of this kind for bonding components such as, in particular, rechargeable batteries and electronic devices such as, in particular, mobile devices, such as mobile phones, for example.

In the present specification, a carrier means a permanent carrier. A permanent carrier is joined firmly to the respective adhesive layer. This means that after the disposition of the adhesive layer on the carrier surface, the carrier can no longer be separated from the adhesive layer without damage to the carrier and/or to the adhesive layer, such as deformation, for example. This notwithstanding, the permanent carrier may be anti-adhesively coated on the side facing away from the adhesive layer, in order, for example, to allow a resulting adhesive tape to be rolled up.

In contrast to this, the present specification understands a liner to be a temporary carrier. In contrast to a (permanent) carrier, then, a liner is not joined firmly to an adhesive layer. In this case, either the liner material itself may already be anti-adhesive as such, or else it is anti-adhesively coated on at least one side, preferably both sides, by siliconization, for example. A liner such as, for example, a release paper or a release film is not a constituent of a pressure-sensitive adhesive strip, being instead merely a tool for its production, storage and/or for further processing by diecutting.

In accordance with the invention, therefore, there are also carriers which, depending to which side the adhesive layer is applied, act as a temporary carrier (liner) or else as a permanent carrier (i.e. carrier within the meaning of the specification). Where a carrier has only a single anti-adhesive surface, while the opposite surface is not anti-adhesive (e.g. a single-sidedly siliconized PET carrier), it functions as a liner when the adhesive layer is applied to the anti-adhesive surface, whereas it functions as a carrier when the adhesive layer is applied to the surface that is not anti-adhesive.

In the present specification, a “disposition” of a foamable layer of self-adhesive composition between two liners, between a liner and a carrier, or between a liner and a further layer of self-adhesive composition refers to a disposition wherein the foamable layer of self-adhesive composition is in direct contact with the surface of the liner, of the carrier and/or of the further layer of self-adhesive composition.

In accordance with the present specification, the terms “pressure-sensitive adhesive” and “self-adhesive” composition (PSAs) are used synonymously. The same is true of the terms “adhesive strip” and “adhesive tape”. The general expression “adhesive strip” (pressure-sensitive adhesive strip) or “adhesive tape” (pressure-sensitive adhesive tape) for the purposes of this invention encompasses all sheet-like structures such as two-dimensionally extended films or film sections, tapes with extended length and limited width, tape sections and the like, ultimately also diecuts or labels. Another typical processed form is a roll of adhesive tape.

In one preferred embodiment, the foamable layer of self-adhesive composition is disposed between (i) two liners, by application of a self-adhesive composition comprising expandable microballoons from a solution to a first liner and drying thereof below the foaming temperature, and by lamination of a second liner to that surface of the dried layer of self-adhesive composition that is opposite the first liner.

In another preferred embodiment, the foamable layer of self-adhesive composition is disposed between (ii) a liner and a carrier, by application of a self-adhesive composition comprising expandable microballoons from a solution to a liner or carrier and drying thereof below the foaming temperature, and by lamination of a carrier or liner to that surface of the dried layer of self-adhesive composition that is opposite the liner or carrier.

In another preferred embodiment, the foamable layer of self-adhesive composition is disposed between (iii) a liner and a further layer of self-adhesive composition, by application of a self-adhesive composition comprising expandable microballoons from a solution to a liner and drying thereof below the foaming temperature, and by lamination of a further layer of self-adhesive composition, typically applied to a liner or carrier, to that surface of the dried layer of self-adhesive composition that is opposite the liner.

The further layer of self-adhesive composition here may (a) be a non-foamable layer of self-adhesive composition. In this case, after the method of the invention has been implemented, the further layer of self-adhesive composition is present in the form, accordingly, of an unfoamed layer of self-adhesive composition.

Alternatively, the further layer of self-adhesive composition may (b) likewise be a foamable layer of self-adhesive composition, in which case the layer of self-adhesive composition typically comprises expandable microballoons. Through a construction of this kind it is possible to generate higher layer thicknesses after foaming, and the resultant product has much fewer visually perceptible defects, such as pinholes or shades of colour. Customarily, in the method of the invention, the further layer of self-adhesive composition is foamed under the same conditions and hence in the same method step as the adjacent foamable layer of self-adhesive composition.

The preferred embodiments of the foamable layer of self-adhesive composition comprising expandable microballoons, and also the at least partially foamed layer of self-adhesive composition resulting therefrom in the method of the invention, are valid in accordance with the invention—unless otherwise indicated—for the further layer of self-adhesive composition as well, before and after foaming.

The chemical composition of the foamable layer of self-adhesive composition and of the further layer of self-adhesive composition may be identical or different, and preferably is identical. Also, the thickness of the foamable layer of self-adhesive composition and of the further layer of self-adhesive composition may be identical or different, and preferably is identical.

Alternatively, moreover, the foamable layer of self-adhesive composition may be disposed between (i) two liners, (ii) a liner and a carrier, or (iii) a liner and a further layer of self-adhesive composition, by lamination of the two liners, of the liner and of the carriers, or of the liner and the further layer of self-adhesive composition, typically applied to a liner or carrier, to the foamable layer of self-adhesive composition. This alternative makes it possible, for example, to replace liners by other liners and/or by carriers and/or by further layers of self-adhesive composition after the production of a foamable layer of self-adhesive composition, in other words prior to foaming.

The laminating here takes place in each case preferably without air inclusions.

If a layer of self-adhesive composition comprising expandable microballoons, also referred to in the sense of the present invention as a foamable layer of self-adhesive composition, is exposed to a suitable elevated temperature, the microballoons expand, causing the layer to foam. Heating of the microballoons raises the internal pressure of the blowing agent included therein and, on further increase in temperature, the shell softens, whereupon the microballoons expand. If the temperature is kept constant or increased further, this leads, through the continuing expansion, to an increasingly thinner shell, and to ever greater microballoon diameters. A multiplicity of unexpanded (and therefore expandable) microballoon types is available commercially, being differentiated substantially via their size and via the onset temperatures required for their expansion (75 to 220° C.). The skilled person is aware that the temperature selected for the foaming is dependent not only on the type of microballoon but also on the desired foaming rate. The absolute density of the layer decreases as a result of the ongoing foaming over a certain period of time. The state of minimum density is defined as full expansion, full foaming, 100% expansion or 100% foaming. The microballoon-containing layers are customarily fully expanded, on the assumption that the desired properties of the layers are achievable with a very low microballoon fraction and/or the properties of the layers are optimized for a given microballoon fraction. Full expansion is therefore considered to be economically and/or technically advantageous. Subsequently, however, the expanded microballoons contract again at the selected foaming temperature, and an overexpanded state is attained, with the density of the layer again being greater in the overexpanded state. The reason for the overexpansion is that the blowing agent begins to diffuse increasingly through the shell and to form free gas bubbles in the surrounding polymer. Overexpansion is unwanted, especially since the emergent gas accumulates in the surrounding polymer where, with increasing time, it forms ever larger free gas bubbles, which reduce the cohesion. Moreover, over time, these free gases diffuse through the surrounding polymer into the environment, and the polymer suffers a loss of foam fraction.

In accordance with the invention, the foamable layer of self-adhesive composition comprising expandable microballoons need not necessarily be a layer of self-adhesive composition comprising unexpanded microballoons. As a foamable layer of self-adhesive composition it is also possible, alternatively, to use a layer of self-adhesive composition which has already undergone partial foaming and therefore comprises expandable microballoons. In the latter case, a partially foamed, and hence foamable, layer of self-adhesive composition is subjected to further foaming.

If the layer of self-adhesive composition in the method of the invention is cooled before full foaming has been reached, the expansion of the microballoons comes to a standstill and, with it, the decrease in the layer density. The term “cooling” here and hereinafter also includes the passive cooling which occurs as a result of removal of heating, i.e. typically a cooling at room temperature (20° C.). In accordance with the invention, furthermore, the term “cooling” also includes heating at a lower temperature. The result is a partially foamed layer. For a suitable choice of the parameters of temperature and time, the foaming operation using microballoons allows the degree of expansion of the microballoons to be adjusted infinitely, also including, of course, a degree of expansion of 100%, i.e. full foaming. The energy input required to achieve the desired degree of expansion is also dependent on the thickness of the adhesive layer to be foamed—as the thickness increases, the energy input required is higher. In practice, typically, the various parameters are modified iteratively until the desired degree of foaming is achieved.

The degree of foaming (degree of expansion) of the partially foamed layer can be calculated, then, as follows:

Degree of foaming=(density of layer comprising unexpanded microballoons minus density of partially foamed layer)/(density of layer comprising unexpanded microballoons minus density of fully foamed layer).

The degree of foaming is the quotient being formed from

(i) the difference in the density of the layer comprising unexpected microballoons and the density of the partially foamed layer, and
(ii) the difference in the density of the layer comprising unexpanded microballoons and the density of the fully foamed layer.

Alternatively to determining the degree of foaming via the densities of the unfoamed, partially foamed and fully foamed layer, it is also possible, analogously, to determine the degree of foaming by the thicknesses of the unfoamed, partially foamed and fully foamed layer.

The degree of foaming is in this case determined as the quotient formed from

(i) the difference in the thickness of the partially foamed layer and the thickness of the layer comprising unexpanded microballoons, and
(ii) the difference in the thickness of the fully foamed layer and the thickness of the layer comprising unexpanded microballoons.

The layer comprising unexpanded microballoons, the partially foamed layer and the fully foamed layer in these calculation formulae are of course layers of identical formulation and identical weight per unit area; in other words, the partially foamed and the fully foamed layers may be provided by the foaming of the layer comprising unexpanded microballoons at a suitable temperature and for a suitable time.

The degree of foaming of a partially foamed layer may alternatively also be determined retrospectively, in other words starting from the completed partially foamed product.

Here again it is possible to use one of the above calculation formulae. The fully foamed layer may be provided by refoaming of the partially foamed layer at a suitable temperature and for a suitable time. In place of the layer comprising unexpanded microballoons, however, the layer included in the calculation formulae is the layer of identical formulation and identical weight per unit area that has been defoamed by the destruction of the voids in the partially foamed layer that result from the expanded microballoons. In order to destroy the foamed microballoons in the partially foamed layer, the specimen under investigation is pressed under reduced pressure. The press parameters in this case are as follows:
temperature: typically at least 30 K above the foaming temperature, such as, for example, 150° C.
pressing force: 10 kN
reduced pressure: −0.9 bar (i.e. 0.9 bar underpressure or 100 mbar residual pressure)
pressing time: 90 s

The degree of foaming of a fully expanded layer, accordingly, is 100%. In the case of overexpanded layers, a negative degree of foaming is reported. In this case the determination is of that fraction of the thickness increase or the density decrease, taking place on transition from the unexpanded to the fully expanded state, that is lost again or gained, respectively, by the subsequent overexpansion.

Surprisingly, partially foamed layers of self-adhesive composition produced by the method of the invention, with a degree of foaming of 20% to less than 100%, preferably 25% to 98%, more preferably 35% to 95%, more preferably still 50% to 90% and more particularly 65% to 90%, such as, for example, 70% to 80%, have shock resistances which are comparable to or even an improvement on those of the corresponding fully expanded layers.

The partial foaming makes it possible, moreover, to produce layers of self-adhesive composition having extremely low thicknesses of, in particular, less than 20 μm, such as 10 to 15 μm, for example. In partially foamed layers of self-adhesive composition of this kind, the average diameter of the voids formed by the microballoons is typically less than 20 μm, more preferably at most 15 μm, such as 10 μm, for example. The use of such thin layers of self-adhesive composition is of particular interest for bonds of those components and electronic devices wherein there is only little space available for the bond, such as, in particular, in mobile devices, such as mobile phones, for example.

A particularly low surface roughness Rₐ of a partially foamed layer of self-adhesive composition can be generated, given choice of a suitable degree of foaming, especially when the layer of self-adhesive composition has a monolayer of microballoons, in other words if within the layer of self-adhesive composition there are not a plurality of microballoons layered above one another. In this case, preferably, the microballoons in the layer of self-adhesive composition are present approximately in one plane. Such a monolayer may be provided, for example, by virtue of the layer of self-adhesive composition having a coatweight, measured in g/m², which is smaller than the average diameter of the voids formed by the microballoons in the partially foamed layer of self-adhesive composition, measured in μm. In the context of the present specification, the coatweight refers to the dry weight of the applied adhesive mixture. The ratio of the coatweight of the layer of adhesive (in g/m²) to the average diameter of the voids formed by the microballoons (in μm) is preferably 0.6-0.9, more preferably 0.7-0.8.

The liners used in accordance with the invention are preferably weight-stable during foaming, and more particularly they lose less than 2%, as for example less than 1%, of their weight during foaming, in the form of water, for example. This is advantageous for the adhesion of the liners to the respective surface of the foamable layer of self-adhesive composition on which they are disposed during foaming. A frequent consequence of extensive weight losses is in particular that the liner lifts from the adhesive.

With regard to the liner adhesion, moreover, it is advantageous if the shrinkage of the liners during foaming, in both the transverse and longitudinal directions, is less than 2%, more preferably less than 1%, and more preferably still less than 0.5%, and if no contraction of the liners during foaming can be found in either the transverse or longitudinal directions.

With regard to liner adhesion it is advantageous, furthermore, if the liners consistently adopt a flat lie during foaming. This means that the liners lie in one plane throughout foaming. With many liners, the problem exists that for lack of temperature stability at customary foaming temperatures, they lose their flat lie and in particular take on a wavy form, possibly with contraction at the same time. A frequent consequence of this is that the layer of adhesive detaches, partially at any rate, from the wavy liner. In the case of a wavy liner, alternatively or additionally, there is also a risk of the layer of adhesive undergoing detachment, at any rate partially, from the liner located on that side of the layer of adhesive that is opposite the wavy liner.

If the liners used do not have complete dimensional stability under foaming conditions, however, both liners ought to have the same characteristics, for example the same contraction behaviour, since otherwise one liner will lift.

The energy needed for foaming is transferred typically by convection, radiation such as IR or UV radiation, or by heat conduction to the assembly formed of foamable layer of self-adhesive composition, liner and optionally carrier and/or further layer of self-adhesive composition. With particular preference, the required energy is transferred by heat conduction uniformly over the web width to the assembly, more particularly by means of one or more heated rolls. In this case, use is made in particular of a sequence of at least two heated rolls, with the assembly being guided over the at least two rolls in such a way that the surfaces of the assembly make reciprocal contact with the roll surfaces.

The method of the invention typically produces at least partially foamed layers of self-adhesive composition, with a thickness of 10 to 2000 μm.

Particularly if the method of the invention results in a foamed transfer tape, i.e. a carrier-less pressure sensitive adhesive tape comprising at least one layer of self-adhesive composition at least partially foamed with microballoons, the foamed layer of self-adhesive composition has a thickness preferably of 30 to 300 μm, such as 150 μm, for example. The assembly composed of a foamable layer of self-adhesive composition between two liners constitutes a preferred transfer tape. The foaming of the layer of self-adhesive composition between the liners, in accordance with the invention, then produces a foamed transfer tape. Correspondingly, the present invention relates to a method for producing a transfer tape in the form of a layer of self-adhesive composition at least partially foamed with microballoons, wherein a foamable layer of self-adhesive composition comprising expandable microballoons and disposed between two liners is heat-treated at a temperature suitable for foaming for a period such that after the subsequent cooling of the layer, the desired degree of foaming is achieved, characterized in that during the foaming the two liners remain adhering substantially completely to the respective surface of the foamable layer of self-adhesive composition on which they are disposed. In an alternative embodiment of the method for producing a foamed transfer tape, as well as a foamable layer of self-adhesive composition comprising expandable microballoons disposed between the liners, prior to foaming, a further layer of self-adhesive composition is disposed, which may be foamable or non-foamable, and which preferably comprises expandable microballoons.

The assembly formed of a foamable layer of self-adhesive composition between a liner and a carrier, as outer layers, constitutes a single-sided adhesive tape. The foaming of the layer of self-adhesive composition, in accordance with the invention, then leads to a foamed single-sided adhesive tape. Accordingly, the present invention also relates to a method for producing a single-sided adhesive tape comprising a layer of self-adhesive composition at least partially foamed with microballoons, wherein a foamable layer of self-adhesive composition comprising expandable microballoons and disposed between a liner and a carrier is heat-treated at a temperature suitable for foaming for a period such that the desired degree of foaming is achieved after the subsequent cooling of the layer, characterized in that during the foaming the liner remains adhering substantially completely on the surface of the foamable layer of self-adhesive composition on which it is disposed. In an alternative embodiment of the method for producing a single-sided adhesive tape, as well as a foamable layer of self-adhesive composition comprising expandable microballoons, adjacent to the carrier, disposed between the liners, prior to foaming, a further layer of self-adhesive composition is disposed, which may be foamable or non-foamable, and which preferably comprises expandable microballoons.

Alternatively, it is possible to dispose a foamable layer of self-adhesive composition on each of both sides of a carrier, with a liner being disposed in turn in each case on the side of the layers of self-adhesive composition that is opposite to the carrier. As already in the case of a transfer tape, this assembly too would constitute a double-sided adhesive tape, albeit a double-sided, carrier-containing adhesive tape. The foaming of the layers of self-adhesive composition, in accordance with the invention, then leads to a foamed, double-sided, carrier-containing adhesive tape. Correspondingly, the present invention also relates to a method for producing a double-sided, carrier-containing adhesive tape, comprising layers of self-adhesive composition at least partially foamed with microballoons, wherein two foamable layers of self-adhesive composition comprising expandable microballoons and disposed on the opposite sides of a carrier, where a liner is disposed on each side of the layers of self-adhesive composition opposite the carrier, are heat-treated at a temperature suitable for foaming for a period such that the desired degree of foaming is achieved after the subsequent cooling of the layers, characterized in that during the foaming, the liners remain adhering substantially completely to the respective surface of the foamable layers of self-adhesive composition on which they are disposed. In an alternative embodiment of the method for producing a double-sided adhesive tape, as well as a foamable layer of self-adhesive composition comprising expandable microballoons, adjacent to the carrier, disposed between the liner and the carrier, prior to foaming, a further layer of self-adhesive composition is disposed, which may be foamable or non-foamable, and which preferably comprises expandable microballoons.

In the double-sided, carrier-containing adhesive tape, the chemical composition of the two foamable layers of self-adhesive composition is preferably identical. More particularly, the adhesive tape is completely symmetrical in construction, in other words in relation both to the chemical composition of the two foamable layers of self-adhesive composition and to its structural composition, by identical pretreatment of both surfaces of the carrier T and by the two foamable layers of self-adhesive composition having the same thickness. Also in accordance with the invention, however, is a double-sided, carrier-containing adhesive tape wherein the two foamable layers of self-adhesive composition have a different chemical composition and/or a different thickness. The above observations are valid analogously for the foamed, double-sided, carrier-containing adhesive tape which is obtainable by the method of the invention.

Accordingly, the adhesive tape of the invention which comprises at least one layer of self-adhesive composition at least partially foamed with microballoons, this layer being obtainable by a method of the invention, may be a transfer tape, a single-sided adhesive tape or a double-sided adhesive tape.

The fraction of the microballoons in the foamable layer of self-adhesive composition is preferably up to 12 wt %, more preferably 0.25 wt % to 5 wt %, even more preferably 0.5 to 4 wt %, more preferably still 0.8 to 3 wt %, more particularly 1 to 2.5 wt %, such as, for example, 1 to 2 wt %, based in each case on the overall composition of the foamable layer of self-adhesive composition. Within these ranges, it is possible to use the method of the invention to produce at least partially foamed layers of self-adhesive composition and/or pressure-sensitive adhesive strips comprising such at least partially foamed layers of self-adhesive composition which have particularly good shock resistances. The stated microballoon fractions result typically in at least partially foamed layers of self-adhesive composition having an absolute density of 400 to 990 kg/m³, preferably 500 to 900 kg/m³, more preferably 600 to 850 kg/m³ and more particularly 650 to 800 kg/m³, such as 700 to 800 kg/m³, for example. The method of the invention also allows the use of high microballoon fractions. Also especially preferred, therefore, are microballoon fractions of more than 0.5 wt %, more particularly more than 1 wt %, as for example more than 2 wt %.

Self-adhesive or pressure-sensitive adhesive compositions are, in particular, polymeric compositions of a kind which—where appropriate by suitable additization with further components, for example tackifying resins—at the temperature of use (unless otherwise defined, at room temperature, i.e. 20° C.) are permanently tacky and adhesive and adhere on contact to a multitude of surfaces, more particularly adhering immediately (exhibiting what is called “tack” [tackiness or touch-tackiness]). Even at the temperature of use, without activation by solvent or by heat—but typically through the influence of a greater or lesser pressure—they are capable of wetting sufficiently a substrate for bonding that interactions sufficient for the adhesion are able to develop between the composition and the substrate. Influencing parameters that are essential in this respect include the pressure and the contact time. The particular properties of the pressure-sensitive adhesives are attributable in particular, among other things, to their viscoelastic properties. Hence, for example, weakly or strongly adhering adhesives can be produced, as can those which are bondable just once and permanently, so that the bond cannot be parted without destruction of the bonding means and/or of the substrates, or bonds which are readily redetachable and possibly can be bonded repeatedly.

Pressure-sensitive adhesives may be produced in principle on the basis of polymers of a variety of chemical natures. The pressure-sensitive adhesive properties are affected by factors including the nature and the proportions of the monomers used in the polymerization of the polymers forming the basis for the pressure-sensitive adhesive, the average molar mass and molar mass distribution of these polymers, and also by the nature and amount of the additives to the pressure-sensitive adhesive, such as tackifying resins, plasticizers and the like.

In order to achieve the viscoelastic qualities, the monomers on which the parent polymers of the pressure-sensitive adhesive are based, and also any further components of the pressure-sensitive adhesive that may be present, are selected in particular such that the pressure-sensitive adhesive has a glass transition temperature (according to DIN 53765:1994-03) below the temperature of use (that is, customarily below the room temperature, i.e. 20° C.).

Where appropriate it may be advantageous to use suitable cohesion-boosting measures, such as, for example, crosslinking reactions (formation of bridge-forming links between the macromolecules), to expand and/or to shift the temperature range within which a polymer composition exhibits pressure-sensitive properties. The range of use of the pressure-sensitive adhesives can therefore be optimized by an adjustment between flowability and cohesion of the composition.

A pressure-sensitive adhesive has permanent pressure-sensitive adhesion at room temperature (20° C.), hence having a sufficiently low viscosity and a high touch-tackiness, so that it wets the surface of the respective bond substrate even at low contact pressure. The bondability of the adhesive derives from its adhesive properties, and the redetachability from its cohesive properties.

In one preferred embodiment, the pressure-sensitive adhesive strip obtainable with the method of the invention can be detached again without residue or destruction by extensive stretching substantially in the plane of the bond. “Residue-free detachment” of the pressure-sensitive adhesive strip means in accordance with the invention that no residues of adhesive are left behind on the bonded surfaces of the components when this strip is detached. Furthermore, “destruction-free detachment” of the pressure-sensitive adhesive strip means in accordance with the invention that it does not damage—destroy, for example—the bonded surfaces of the components when it is detached.

So that pressure-sensitive adhesive strips can be redetached without residue or destruction by extensive stretching in the bond plane, they are required to possess certain technical adhesive properties. Hence, during stretching, the tackiness of the pressure-sensitive adhesive strips must drop significantly. The lower the bonding performance in the stretched state, the less the extent to which the substrate is damaged during detachment or the lower the risk of residues remaining on the bond substrate. This quality is particularly marked in pressure-sensitive adhesives based on vinylaromatic block copolymers, for which the tackiness drops to below 10% in the vicinity of the yield point.

So that pressure-sensitive adhesive strips can be redetached easily and without residue by extensive stretching, they are required to have certain mechanical properties as well, in addition to the technical adhesive properties described above. With particular advantage the ratio of the tearing force (tear strength) to the stripping force is greater than two, preferably greater than three. The stripping force here is the force necessarily expended in order to redetach a pressure-sensitive adhesive strip from a bond line by extensive stretching in the bond plane. This stripping force is made up of the force which is needed, as described above, for the detachment of the pressure-sensitive adhesive strip from the bond substrates, and the force which has to be expended in order to deform the pressure-sensitive adhesive strip. The force needed to deform the pressure-sensitive adhesive strip is dependent on the thickness of the pressure-sensitive adhesive strip. Within the thickness range under consideration for the pressure-sensitive adhesive strip, in contrast, the force required for detachment is independent of the thickness of the pressure-sensitive adhesive strip.

Where a carrier is used in the method of the invention, suitability is possessed in principle by all known (permanent) carriers, such as, for example, laid scrims, woven, knitted and nonwoven fabrics, papers, tissues, and film carriers. Film carriers are used typically, and may have been foamed (for example, thermoplastic foams) or may be unfoamed. The film carrier is produced using typically film-forming or extrudable polymers, which additionally may have undergone monoaxial or biaxial orientation. A typical carrier thickness is in the range from 5 to 150 μm.

The film carriers may be single-layer or multi-layer; preferably they are single-layer. Furthermore, the film carriers may have outer layers, blocking layers for example, which prevent penetration of components from the adhesive into the film or vice versa. These outer layers may also have barrier properties, so as to prevent diffusion of water vapour and/or oxygen through the layer. The reverse of the film carriers may have undergone anti-adhesive physical treatment or coating.

In order to produce a film carrier it may be appropriate to add additives and further components which improve the film-forming properties, reduce the tendency for crystalline segments to develop, and/or targetedly improve or else, where appropriate, impair the mechanical properties.

A film carrier may be non-extensible, having preferably a thickness of 5 to 125 μm, more preferably of 5 to 40 μm and more particularly of less than 10 μm. Alternatively a film carrier may be extensible, preferably viscoelastic, with the extensible film carrier preferably having a thickness of 50 to 150 μm, more preferably of 60 to 100 μm and more particularly of 70 μm to 75 μm.

A “non-extensible film carrier” in accordance with the invention refers in particular to a film carrier which, preferably both in the longitudinal direction and in the transverse direction, has an elongation at break of less than 300%. The non-extensible film carrier also has, preferably independently of one another both in the longitudinal direction and in the transverse direction, a preferred elongation at break of less than 200%, more preferably of less than 150%, more preferably still of less than 100%, and more particularly of less than 50%. The stated values are based in each case on the measurement method R1 indicated later on below.

An “extensible film carrier” in accordance with the invention refers in particular to a film carrier which, preferably both in the longitudinal direction and in the transverse direction, has an elongation at break of at least 300%. The extensible film carrier, preferably independently of one another both in the longitudinal direction and in the transverse direction, also has an elongation at break of at least 500%, as for example of at least 800%. The stated values are based in each case on the measurement method R1 indicated later on below.

The use of a non-extensible film carrier in the method of the invention makes it easier to process the resultant adhesive tape, and may more particularly facilitate the diecutting operations. In diecuts, the non-extensible film carrier results in pronounced stiffness, thereby simplifying the diecutting operation and the placement of the diecuts. Materials used for the film of the non-extensible film carrier are preferably polyesters, more particularly polyethylene terephthalate (PET), polyamide (PA), polyimide (PI) or monoaxially or biaxially oriented polypropylene (PP). With particular preference the non-extensible film carrier consists of polyethylene terephthalate. Also possible, likewise, is the use of multi-layer laminates or coextrudates, more particularly made up of the aforesaid materials. With preference the non-extensible film carrier is single-layered.

In an advantageous procedure, one or both surfaces of the non-extensible film carrier are physically and/or chemically pretreated. Such pretreatment may take place, for example, by etching and/or corona treatment and/or plasma pretreatment and/or priming, preferably by means of etching. If both surfaces of the carrier are pretreated, the pretreatment of each surface may be different or, in particular, both surfaces may have the same pretreatment.

In order to obtain very good results for the roughening, it is advisable to use, as a film etching reagent, trichloroacetic acid (Cl3C—COOH) or trichloroacetic acid in combination with inert pulverulent compounds, preferably silicon compounds, more preferably [SiO2]x. The purpose of the inert compounds is to be installed into the surface of the film, more particularly of the PET film, in order thus to boost the roughness and the surface energy.

Corona treatment is a chemical/thermal process for raising the surface tension/surface energy of polymeric substrates. Electrons are greatly accelerated in a high-voltage discharge between two electrodes, leading to ionization of the air. If a plastics substrate is introduced into the path of these accelerated electrons, the accelerated electrons thus produced strike the substrate surface with 2-3 times the energy that will be needed to break the molecular bonds of the surface of most substrates. This leads to formation of gaseous reaction products and of highly reactive free radicals. These free radicals can react rapidly in the presence of oxygen and the reaction products, and form various chemical functional groups on the substrate surface. Functional groups that result from these oxidation reactions make the greatest contribution to increasing the surface energy. The corona treatment can be carried out with two-electrode systems, or else with one-electrode systems. During the corona pretreatment, (as well as the usual air) it is possible to use different process gases such as nitrogen that form a protective gas atmosphere and/or promote the corona pretreatment.

Plasma treatment—more particularly low-pressure plasma treatment—is a known process for the surface pretreatment of adhesives. The plasma leads to activation of the surface in the sense of a higher reactivity. Chemical changes occur to the surface, thus making it possible, for example, to influence the behaviour of the adhesive with respect to polar and non-polar surfaces. This pretreatment substantially entails surface phenomena.

Primers, generally, are coatings or basecoats which in particular possess an adhesion-promoting and/or passivating and/or corrosion-inhibiting effect. In the context of the present invention, it is the adhesion-promoting effect that is particularly important. Adhesion-promoting primers, often also called adhesion promoters, are widely known in the form of commercial products or from the technical literature.

One suitable non-extensible film carrier is available under the trade name Hostaphan® RNK. This film is highly transparent and biaxially oriented and consists of three coextruded layers.

The tensile strength of a non-extensible film carrier in accordance with the invention is preferably greater than 100 N/mm², more preferably greater than 150 N/mm², more preferably still greater than 180 N/mm² and more particularly greater than 200 N/mm² in longitudinal direction and preferably greater than 100 N/mm², more preferably greater than 150 N/mm², more preferably still greater than 180 N/mm², and more particularly greater than 200 N/mm² in transverse direction (stated values each in relation to the measurement method R1 indicated later on below). The film carrier critically determines the tensile strength of the eventual adhesive tape. Moreover, the elasticity modulus of the non-extensible film carrier is preferably more than 0.5 GPa, more preferably more than 1 GPa and more particularly more than 2.5 GPa, preferably both in the longitudinal direction and in the transverse direction.

The use of an extensible film carrier permits other advantageous product architectures. Where the method of the invention uses an extensible film carrier, the extensibility of the film carrier is typically sufficient to ensure detachment of the pressure-sensitive adhesive strip by extensive stretching substantially in the bond plane. The extensible film carrier preferably has a resilience of more than 50%, preferably both in the longitudinal direction and in the transverse direction. The tensile strength of the extensible carrier material is preferably set such that the pressure-sensitive adhesive strip is redetachable without residue or destruction from an adhesive bond by means of extensive stretching.

In one preferred embodiment of an extensible film carrier, polyolefins are used. Preferred polyolefins are prepared from ethylene, propylene, butylene and/or hexylene, it being possible in each case to polymerize the pure monomers or to copolymerize mixtures of the stated monomers. Through the polymerization process and through the selection of the monomers it is possible to direct the physical and mechanical properties of the polymer film such as, for example, the softening temperature and/or the tear strength. Particularly preferred is polyethylene, more particularly polyethylene foam.

Polyurethanes, furthermore, may be used advantageously as starting materials for extensible film carriers. Polyurethanes are chemically and/or physically crosslinked polycondensates constructed typically from polyols and isocyanates. Depending on the nature of the individual components and the ratio in which they are used, extensible materials are obtainable which can be employed advantageously for the purposes of this invention. Particularly preferred is polyurethane foam.

It is advantageous, moreover, to use rubber-based materials in extensible film carriers in order to realize extensibility. As rubber or synthetic rubber or blends produced therefrom, as starting material for extensible film carriers, the natural rubber may be selected in principle from all available grades such as, for example, crepe, RSS, ADS, TSR or CV products, according to required level of purity and level of viscosity, and the synthetic rubber or the synthetic rubbers may be selected from the group of randomly copolymerized styrene-butadiene rubbers (SBR), styrene block copolymers (SBC), butadiene rubbers (BR), synthetic polyisoprenes (IR), butyl rubbers (IIR), halogenated butyl rubbers (XIIR), ethylene-vinyl acetate copolymers (EVA) and polyurethanes and/or blends thereof.

Employable with particular advantage as materials for extensible film carriers are block copolymers, where individual polymer blocks are linked covalently to one another. The block linkage may be in a linear form, or else in a star-shaped or graft copolymer variant. One example of an advantageously employable block copolymer is a linear triblock copolymer whose two end blocks have a softening temperature of at least 40° C., preferably at least 70° C., and whose middle block has a softening temperature of at most 0° C., preferably at most −30° C. Higher block copolymers, for instance tetrablock copolymers, are likewise employable. It is important that at least two polymer blocks of same or different kinds are present in the block copolymer and have a softening temperature in each case of at least 40° C., preferably at least 70° C., and are separated from one another by at least one polymer block having a softening temperature of at most 0° C., preferably at most −30° C., in the polymer chain. Examples of polymer blocks are polyethers such as, for example, polyethylene glycol, polypropylene glycol or polytetrahydrofuran, polydienes, such as, for example, polybutadiene or polyisoprene, hydrogenated polydienes, such as, for example, polyethylene-butylene or polyethylene-propylene, polyesters, such as, for example, polyethylene terephthalate, polybutanediol adipate or polyhexanediol adipate, polycarbonate, polycaprolactone, polymer blocks of vinylaromatic monomers, such as, for example, polystyrene or poly-[a]-methylstyrene, polyalkyl vinyl ethers and polyvinyl acetate. Polymer blocks can be constructed from copolymers.

Particularly if the layer of self-adhesive composition is based on vinylaromatic block copolymer such as styrene block copolymer, the extensible film carrier is based preferably on polyvinylaromatic-polydiene block copolymer, more particularly on polyvinylaromatic-polybutadiene block copolymer, and also typically on tackifying resin. A film carrier of this kind is convincing particularly by virtue of a low stripping force, allowing ready redetachability of the pressure-sensitive adhesive strip, and also by low susceptibility to tearing on redetachment of the pressure-sensitive adhesive strip.

Additionally conceivable as extensible film carriers are non-syntactic foams (made from polyethylene or polyurethane, for example) in web form.

Additionally conceivable as extensible film carriers are polyacrylate cores. In accordance with the invention they are not foamed.

For better anchorage of the self-adhesive compositions on the extensible film carriers, the film carriers may be pretreated by the known measures such as corona, plasma or flaming. Utilization of a primer is also possible. Ideally, however, there is no need for pretreatment.

Liners for self-adhesive tapes are based frequently on biaxially or monoaxially oriented polypropylene, on polyethylene or on other polyolefins, on paper or on polyester. Such liners frequently also have a multi-layer construction or coating. Frequently such liners are siliconized on one or both sides. The liners used in the method of the invention are preferably polyester liners such as, in particular, PET liners, which at least one-sidedly, typically both-sidedly, are anti-adhesively coated, being siliconized, for example. The polyester liners typically have a thickness of more than 12 μm and up to 200 μm, preferably from 40 to less than 100 μm, more particularly from 50 to 75 μm. The polyester liners described adhere particularly well during foaming to the foamable layer of self-adhesive composition on which they are disposed. In the method of the invention, however, it is also possible to use other liners, provided that during foaming they remain adhering completely to the foamable layer of self-adhesive composition on which they are disposed. The suitability is influenced in particular by the nature of the liner material and also by the thickness of the liner.

Employed preferably in the method of the invention are the following foamable layers of self-adhesive composition comprising expandable microballoons, also referred to below as self-adhesive compositions or layers of self-adhesive composition.

The layers of self-adhesive composition may be based on various polymers or polymer compositions. Based on a polymer or on a defined polymer composition in this sense means typically that the said polymer takes on the function of the elastomer component to an extent of at least 50 wt %, based on the overall fraction of all the elastomer components. With preference the said polymer alone is provided as elastomer component. This base polymer may also be a polymer mixture. The base polymer, moreover, represents preferably at least 50 wt % of the polymers present in the adhesive, and may also, for example, constitute the only polymer of the adhesive. In this context, any tackifying resins present in the adhesive are not considered as polymers.

The layers of self-adhesive composition are based preferably on synthetic rubber compositions, such as vinylaromatic block copolymer compositions, for example, that in particular are chemically or physically crosslinked. Synthetic rubbers typically have a high tackiness (as a result of the tackifying resins), feature very good peel adhesion on polar and on non-polar substrates such as polypropylene and polyethylene, and are suitable for a broad utility spectrum.

The layers of self-adhesive composition may also be based preferably on acrylate compositions. These typically are transparent, highly stable to ageing, temperature, UV radiation, ozone, humidity, solvents and/or plasticizers, and have very good peel adhesion on polar substrates. In the present specification, the terms “acrylate” and “polyacrylate” are used synonymously. This refers in each case to a polymer originating from polymerization of (meth)acrylic acid, an ester thereof or mixtures of the aforesaid monomers, and optionally further copolymerizable monomers. The term “(meth)acrylic acid”, moreover, encompasses both acrylic acid and methacrylic acid. Typically the polyacrylates are copolymers.

Also in accordance with the invention are layers of self-adhesive composition based on a blend of acrylate and synthetic rubber, such as vinylaromatic block copolymer, for example, that is, in particular, crosslinked chemically or physically.

Also in accordance with the invention are layers of self-adhesive composition based on natural rubbers. The latter typically feature high tackiness (as a result of the tackifying resins), very good peel adhesion on polar and on non-polar substrates, and residue-free removability.

When the layer of self-adhesive composition is based on a vinylaromatic block copolymer composition, then the vinylaromatic block copolymer used is preferably at least one synthetic rubber in the form of a block copolymer having an A-B, A-B-A, (A-B)ₙ, (A-B)ₙX or (A-B-A)ₙX construction, in which
the A blocks are independently a polymer formed by polymerization of at least one vinylaromatic,
the B blocks are independently a polymer formed by polymerization of conjugated dienes having 4 to 18 carbon atoms, or a partly hydrogenated derivative of such a polymer,
X is the radical of a coupling reagent or initiator and
n is an integer ≥2.

More preferably, all synthetic rubbers in the self-adhesive composition layer of the invention are block copolymers having an A-B, A-B-A, (A-B)ₙ, (A-B)ₙX or (A-B-A)ₙX construction as set out above. The self-adhesive composition layer of the invention may thus also comprise mixtures of various block copolymers having a construction as described above.

Suitable block copolymers (vinylaromatic block copolymers) thus comprise one or more rubber-like blocks B (soft blocks) and one or more glass-like blocks A (hard blocks). More preferably, at least one synthetic rubber in the self-adhesive composition layer of the invention is a block copolymer having an A-B, A-B-A, (A-B)₂X, (A-B)₃X or (A-B)₄X construction, where the above meanings are applicable to A, B and X. Most preferably, all synthetic rubbers in the self-adhesive composition layer of the invention are block copolymers having an A-B, A-B-A, (A-B)₂X, (A-B)₃X or (A-B)₄X construction, where the above meanings are applicable to A, B and X. More particularly, the synthetic rubber in the self-adhesive composition layer of the invention is a mixture of block copolymers having an A-B, A-B-A, (A-B)₂X, (A-B)₃X or (A-B)₄X construction, preferably comprising at least diblock copolymers A-B and/or triblock copolymers A-B-A and/or (A-B)₂X.

Also advantageous is a mixture of diblock and triblock copolymers and (A-B)ₙ or (A-B)ₙX block copolymers with n not less than 3.

Also advantageous is a mixture of diblock and multiblock copolymers and (A-B)ₙ or (A-B)ₙX block copolymers with n not less than 3.

Vinylaromatic block copolymers utilized may thus, for example, be diblock copolymers A-B in combination with others among the block copolymers mentioned. It is possible to use the proportion of diblock copolymers to adjust the flow-on characteristics of the self-adhesive compositions and the bond strength thereof. Vinylaromatic block copolymer used in accordance with the invention preferably has a diblock copolymer content of 0% to 70% by weight and more preferably of 15% to 50% by weight. A higher proportion of diblock copolymer in the vinylaromatic block copolymer leads to a distinct reduction in cohesion of the adhesive composition.

The self-adhesive compositions employed are preferably those based on block copolymers comprising polymer blocks (i) predominantly formed from vinylaromatics (A blocks), preferably styrene, and simultaneously (ii) those predominantly formed by polymerization of 1,3-dienes (B blocks), for example butadiene and isoprene or a copolymer of the two.

More preferably, self-adhesive compositions of the invention are based on styrene block copolymers; for example, the block copolymers of the self-adhesive compositions have polystyrene end blocks.

The block copolymers that result from the A and B blocks may contain identical or different B blocks. The block copolymers may have linear A-B-A structures. It is likewise possible to use block copolymers in radial form and star-shaped and linear multiblock copolymers. Further components present may be A-B diblock copolymers. All the aforementioned polymers can be utilized alone or in a mixture with one another.

In a vinylaromatic block copolymer used in accordance with the invention, such as a styrene block copolymer in particular, the proportion of polyvinylaromatics, such as polystyrene in particular, is preferably at least 12% by weight, more preferably at least 18% by weight and especially preferably at least 25% by weight, and likewise preferably at most 45% by weight and more preferably at most 35% by weight.

Rather than the preferred polystyrene blocks, vinylaromatics used may also be polymer blocks based on other aromatic-containing homo- and copolymers (preferably C8 to C12 aromatics) having glass transition temperatures of greater than 75° C., for example α-methylstyrene-containing aromatic blocks. In addition, it is also possible for identical or different A blocks to be present.

Preferably, the vinylaromatics for formation of the A block include styrene, α-methylstyrene and/or other styrene derivatives. The A block may thus be in the form of a homo- or copolymer. More preferably, the A block is a polystyrene.

Preferred conjugated dienes as monomers for the soft block B are especially selected from the group consisting of butadiene, isoprene, ethylbutadiene, phenylbutadiene, piperylene, pentadiene, hexadiene, ethylhexadiene and dimethylbutadiene, and any desired mixtures of these monomers. The B block may also be in the form of a homopolymer or copolymer.

More preferably, the conjugated dienes as monomers for the soft block B are selected from butadiene and isoprene. For example, the soft block B is a polyisoprene, a polybutadiene or a partly hydrogenated derivative of one of these two polymers, such as polybutylene-butadiene in particular, or a polymer formed from a mixture of butadiene and isoprene. Most preferably, the B block is a polybutadiene.

A blocks are also referred to as “hard blocks” in the context of this invention. B blocks are correspondingly also called “soft blocks” or “elastomer blocks”. This is reflected by the inventive selection of the blocks in accordance with their glass transition temperatures (for A blocks at least 25° C., especially at least 50° C., and for B blocks at most 25° C., especially at most −25° C.).

The proportion of the vinylaromatic block copolymers, such as styrene block copolymers in particular, preferably based on the overall self-adhesive composition layer, totals at least 20% by weight, preferably at least 30% by weight, further preferably at least 35% by weight. Too low a proportion of vinylaromatic block copolymers results in relatively low cohesion of the self-adhesive composition.

The maximum proportion of the vinylaromatic block copolymers, such as styrene block copolymers in particular, based on the overall self-adhesive composition, totals at most 75% by weight, preferably at most 65% by weight, further preferably at most 55% by weight. Too high a proportion of vinylaromatic block copolymers in turn results in barely any pressure-sensitive adhesion in the pressure-sensitive adhesive composition.

The pressure-sensitive adhesion of the self-adhesive compositions based on vinylaromatic block copolymer can be achieved by addition of tackifying resins that are miscible with the elastomer phase. The self-adhesive compositions generally include, as well as the at least one vinylaromatic block copolymer, at least one tackifying resin in order to increase the adhesion in the desired manner. The tackifying resin should be compatible with the elastomer block of the block copolymers.

A “tackifying resin” (tackifier), in accordance with the general understanding of the person skilled in the art, is understood to mean a low molecular mass, oligomeric or polymeric resin that increases the adhesion (tack, intrinsic tackiness) of the self-adhesive composition compared to the self-adhesive composition that does not contain any tackifying resin but is otherwise identical.

If tackifying resin is present in the self-adhesive compositions, a resin having a DACP (diacetone alcohol cloud point) of greater than 0° C., preferably greater than 10° C., an MMAP (mixed methylcyclohexane aniline point) of at least 50° C., preferably at least 60° C., and/or a softening temperature (ring & ball) of not less than 70° C., preferably not less than 100° C., is chosen to an extent of at least 75% by weight, based on the total resin content. More preferably, the tackifying resin mentioned simultaneously has a DACP value of less than 50° C. if no isoprene blocks are present in the elastomer phase, or of less than 65° C. if isoprene blocks are present in the elastomer phase. Also more preferably, the stated tackifying resin simultaneously has an MMAP of at most 90° C., if no isoprene blocks are in the elastomer phase, or of at most 100° C., if isoprene blocks are in the elastomer phase. Also more preferably, the softening temperature of the tackifying resin mentioned is not more than 150° C.

More preferably, the tackifying resins comprise at least 75% by weight, based on the total resin content, of hydrocarbon resins or terpene resins or a mixture of the same.

It has been found that tackifiers advantageously usable for the self-adhesive compositions are especially nonpolar hydrocarbon resins, for example hydrogenated and non-hydrogenated polymers of dicyclopentadiene, non-hydrogenated, partly, selectively or fully hydrogenated hydrocarbon resins based on C5, C5/C9 or C9 monomer streams, and polyterpene resins based on α-pinene and/or β-pinene and/or δ-limonene. The aforementioned tackifying resins can be used either alone or in a mixture. It is possible to use both room temperature (20° C.) solid resins and liquid resins. Tackifying resins, in hydrogenated or non-hydrogenated form, which also contain oxygen can optionally and preferably be used in the adhesive composition up to a maximum proportion of 25%, based on the total mass of the resins, for example rosins and/or rosin esters and/or terpene-phenol resins.

The proportion of the optionally usable resins or plasticizers that are liquid at room temperature (20° C.), in a preferred variant, is up to 15% by weight, preferably up to 10% by weight, based on the overall self-adhesive composition.

In a preferred embodiment, 20% to 60% by weight of at least one tackifying resin, based on the total weight of the self-adhesive composition layer, preferably 30% to 50% by weight of at least one tackifying resin, based on the total weight of the self-adhesive composition layer, is present in the self-adhesive composition layers.

Further additives to a vinylaromatic block copolymer-based self-adhesive composition that can typically be utilized are:
plasticizers, for example plasticizer oils, or low molecular weight liquid polymers, for example low molecular weight polybutenes, preferably with a proportion of 0.2% to 5% by weight, based on the total weight of the self-adhesive composition,
primary antioxidants, for example sterically hindered phenols, preferably with a proportion of 0.2% to 1% by weight, based on the total weight of the self-adhesive composition,
secondary antioxidants, for example phosphites, thioesters or thioethers, preferably with a proportion of 0.2% to 1% by weight, based on the total weight of the self-adhesive composition,
process stabilizers, for example carbon radical scavengers, preferably with a proportion of 0.2% to 1% by weight, based on the total weight of the self-adhesive composition,
light stabilizers, for example UV absorbers or sterically hindered amines, preferably with a proportion of 0.2% to 1% by weight, based on the total weight of the self-adhesive composition,
processing auxiliaries, preferably with a proportion of 0.2% to 1% by weight, based on the total weight of the self-adhesive composition,
end block reinforcer resins, preferably with a proportion of 0.2% to 10% by weight, based on the total weight of the self-adhesive composition, and
optionally further polymers that are preferably elastomeric in nature;
   correspondingly utilizable elastomers include those based on pure hydrocarbons, for example unsaturated polydienes such as natural or synthetically produced polyisoprene or polybutadiene, essentially chemically saturated elastomers, for example saturated ethylene-propylene copolymers, α-olefin copolymers, polyisobutylene, butyl rubber, ethylene-propylene rubber, and chemically functionalized hydrocarbons, for example halogenated, acrylated, allyl or vinyl ether-containing polyolefins,
   preferably with a proportion of 0.2% to 10% by weight, based on the total weight of the self-adhesive composition.

The nature and amount of the blend components can be selected as required.

It is also in accordance with the invention when the adhesive composition does not have some of and preferably any of the admixtures mentioned.

In one embodiment of the present invention, the vinylaromatic block copolymer-based self-adhesive composition also comprises further additives; nonlimiting examples include crystalline or amorphous oxides, hydroxides, carbonates, nitrides, halides, carbides or mixed oxide/hydroxide/halide compounds of aluminium, of silicon, of zirconium, of titanium, of tin, of zinc, of iron or of the alkali metals/alkaline earth metals. These are essentially aluminas, for example aluminium oxides, boehmite, bayerite, gibbsite, diaspore and the like. Sheet silicates are very particularly suitable, for example bentonite, montmorillonite, hydrotalcite, hectorite, kaolinite, boehmite, mica, vermiculite or mixtures thereof. But it is also possible to use carbon blacks or further polymorphs of carbon, for instance carbon nanotubes.

The adhesive compositions may also be coloured with dyes or pigments. The adhesive compositions may be white, black or coloured. The plasticizers metered in may, for example, be mineral oils, (meth)acrylate oligomers, phthalates, cyclohexanedicarboxylic esters, water-soluble plasticizers, plasticizing resins, phosphates or polyphosphates. The addition of silicas, advantageously of precipitated silica surface-modified with dimethyldichlorosilane, can be utilized in order to increase further the thermal shear strength of the self-adhesive composition.

In a preferred embodiment of the invention, the adhesive composition consists solely of vinylaromatic block copolymers, tackifying resins, microballoons and optionally the abovementioned additives.

The foaming of the invention typically is effected by the introduction and subsequent expansion of microballoons.

“Microballoons” are understood to mean hollow microbeads that are elastic and hence expandable in their ground state, having a thermoplastic polymer shell. These beads have been filled with low-boiling liquids or liquefied gas. Shell material employed is especially polyacrylonitrile, PVDC, PVC or polyacrylates. Suitable low-boiling liquids are especially hydrocarbons from the lower alkanes, for example isobutane or isopentane, that are enclosed in the polymer shell under pressure as liquefied gas.

Outside action on the microballoons, especially by the action of heat, results in softening of the outer polymer shell. At the same time, the liquid blowing gas present within the shell is converted to its gaseous state. This causes irreversible extension and three-dimensional expansion of the microballoons. Since the polymeric shell is conserved during foaming, what is achieved is thus a closed-cell foam.

A multitude of unexpanded microballoon types is commercially available, which differ essentially in terms of their size and the starting temperatures that they require for expansion (75 to 220° C.). One example of commercially available unexpanded microballoons is the Expancel® DU products (DU=dry unexpanded) from Akzo Nobel. In the product designation Expancel xxx DU yy, “xxx” represents the composition of the microballoon mixture, and “yy” the size of the microballoons in the expanded state.

Unexpanded microballoon products are also available in the form of an aqueous dispersion having a solids/microballoon content of about 40% to 45% by weight, and additionally also in the form of polymer-bound microballoons (masterbatches), for example in ethylene-vinyl acetate with a microballoon concentration of about 65% by weight. Both the microballoon dispersions and the masterbatches, like the DU products, are suitable for production of a foamed self-adhesive composition.

In the method of the invention, the foamable self-adhesive composition layer used may also be a self-adhesive composition layer comprising partially expanded microballoons, i.e. those having already pre-expanded to the desired degree. Partial expansion takes place typically prior to incorporation into the polymer matrix.

In the processing of already partially expanded microballoon types, it is possible that the microballoons, because of their low density in the polymer matrix into which they are to be incorporated, will have a tendency to float, i.e. to rise “upward” in the polymer matrix during the processing operation. This leads to inhomogeneous distribution of the microballoons in the layer. In the upper region of the layer (z direction), more microballoons are to be found than in the lower region of the layer, such that a density gradient across the layer thickness is established.

In order to largely or very substantially prevent such a density gradient, preference is given in accordance with the invention to incorporating only a low level of, if any, pre-expanded microballoons into the polymer matrix of the self-adhesive composition layer. The microballoons are expanded to the desired degree of foaming only after incorporation, coating, drying (solvent evaporation). Preference is therefore given in accordance with the invention to using DU products.

The microballoons can be supplied to the formulation of the self-adhesive composition in the form of a batch, paste or unextended or extended powder. They can also be present in suspension in solvent.

A self-adhesive composition of the invention comprising expandable hollow microspheres may additionally also comprise non-expandable hollow microspheres. All that is critical is that virtually all of the gas-containing cavities are closed by a permanently sealing membrane, irrespective of whether that membrane consists of an elastic and thermoplastically extensible polymer mixture or of elastic glass which—in the spectrum of temperatures possible in plastics processing—is non-thermoplastic.

In a further preferred embodiment, the layers of self-adhesive composition are based on acrylate compositions.

In order to achieve pressure-sensitive properties, the adhesive ought at the processing temperature to be above its glass transition temperature, in order to have viscoelastic properties. The glass transition temperature of the pressure-sensitive adhesive formulation (polymer/tackifier mixture) is therefore preferably below +15° C. The possible addition of tackifying resin inevitably raises the glass transition temperature, depending on amount added, compatibility and softening temperature, by around 5 to 40 K. Preferred polyacrylates are therefore those having a glass transition temperature of at most 0° C.

The polyacrylate is obtained preferably by radical polymerization of (meth)acrylic acid and/or esters thereof and optionally further, copolymerizable monomers.

In accordance with the invention the polyacrylate may be a polyacrylate crosslinkable with epoxide groups. Correspondingly, monomers or comonomers preferably used are functional monomers crosslinkable with epoxide groups. In particular, monomers with acid groups (especially carboxylic acid, sulphonic acid or phosphonic acid groups) and/or hydroxyl groups and/or acid anhydride groups and/or epoxide groups and/or amine groups are employed; monomers containing carboxylic acid groups are preferred. It is especially advantageous if the polyacrylate contains copolymerized acrylic acid and/or methacrylic acid. Other monomers which can be used as comonomers for the polyacrylate are, for example, acrylic and/or methacrylic esters having up to 30 carbon atoms, vinyl esters of carboxylic acids containing up to 20 carbon atoms, vinylaromatics having up to 20 carbon atoms, (meth)acrylamide, maleic anhydride, ethylenically unsaturated nitriles, vinyl halides, vinyl esters, especially vinyl acetate, vinyl alcohols, vinyl ethers of alcohols containing 1 to 10 carbon atoms, aliphatic hydrocarbons having 2 to 8 carbon atoms and 1 or 2 double bonds, or mixtures of these monomers. The residual solvent content ought to be below 1% by weight.

Employed preferably is a polyacrylate which can be ascribed to the following monomer composition:

(i) acrylic acid (esters) and/or methacrylic acid (esters) of the following formula

CH2═C(R¹)(COOR²)

where R¹ is H or CH3 and R² is H or linear, branched or cyclic, saturated or unsaturated alkyl radicals having 1 to 30, more particularly having 4 to 18, carbon atoms,
(ii) optionally olefinically unsaturated comonomers having functional groups which bring about crosslinkability with epoxide groups,
(iii) optionally further acrylates and/or methacrylates and/or olefinically unsaturated monomers which are copolymerizable with component (i).

To prepare the polyacrylate it is very advantageous to select the monomers (i) with a fraction of 45 to 99% by weight, the monomers (ii) with a fraction of 1% to 15% by weight and the monomers of component (iii) with a fraction of 0% to 40% by weight (the figures are based on the monomer mixture used).

The monomers of component (i) are, in particular, plasticizing and/or non-polar monomers. The monomers (i) are preferably acrylic and/or methacrylic esters having alkyl groups of 4 to 18 carbon atoms, more preferably 4 to 9 carbon atoms. Examples of such monomers are n-butyl acrylate, n-butyl methacrylate, n-pentyl acrylate, n-pentyl methacrylate, n-amyl acrylate, n-hexyl acrylate, hexyl methacrylate, n-heptyl acrylate, n-octyl acrylate, n-octyl methacrylate, n-nonyl acrylate, isobutyl acrylate, isooctyl acrylate, isooctyl methacrylate and the branched isomers thereof such as, for example, 2-ethylhexyl acrylate or 2-ethylhexyl methacrylate.

For component (ii), preference is given to using monomers with functional groups selected from the following list: hydroxyl, carboxyl, sulfonic acid or phosphonic groups, acid anhydrides, epoxides, amines. Particularly preferred examples of monomers (ii) are acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate. Exemplary monomers for component (iii) are as follows: methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethylacrylate, methoxy-polyethylene glycol methacrylate 350, methoxy-polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides such as, for example N,N-dimethylacrylamide, N,N-dimethylmethacrylamide, N-benzylacrylam ides, N-isopropylacrylamide, N-tert-butylacrylamide, N-tert-octylacrylamide, N-methylolacrylamide, N-methylolmethacrylamide, acrylonitrile, methacrylonitrile, vinyl ethers such as vinyl methyl ether, ethyl vinyl ether, vinyl isobutyl ether, vinyl esters such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, macromonomers such as 2-polystyrene-ethyl methacrylate and poly(methyl methacrylate)ethyl methacrylate.

The monomer mixture may further comprise preferably (I) 90% to 99% by weight of n-butyl acrylate and/or 2-ethylhexyl acrylate and also (II) 1% to 10% by weight of an ethylenically unsaturated monomer having an acid function or acid anhydride function, where preferably (I) and (II) add up to 100% by weight. The monomer (I) preferably forms a mixture of 2-ethylhexyl acrylate and n-butyl acrylate, more preferably in equal parts. Contemplated advantageously as monomer (II) are, for example, acrylic acid, methacrylic acid, itaconic acid, maleic acid, fumaric acid and/or maleic anhydride. Preferred are acrylic acid or methacrylic acid, optionally a mixture of both.

In an alternative embodiment the layers of self-adhesive composition are based on a blend of acrylate and, preferably chemically or physically crosslinked, synthetic rubber such as, for example, vinylaromatic block copolymer. The self-adhesive composition layers therefore comprise at least the following two components:

(P) a polyacrylate component, i.e. polyacrylate, and
(E) an elastomer component which is substantially immiscible with the polyacrylate component and is formed by one or more synthetic rubbers, such as vinylaromatic block copolymers; i.e., synthetic rubber such as vinylaromatic block copolymer. With regard to the preferred construction of the polyacrylates and vinylaromatic block copolymers, the above observations relating to the self-adhesive composition layers based on vinylaromatic block copolymer compositions and on acrylate compositions are valid analogously. The adhesive therefore has at least two separate phases. More particularly, one phase forms a matrix and the other phase forms a multitude of domains disposed within the matrix. The polyacrylate component (P) itself preferably constitutes a homogeneous phase. The elastomer component (E) may be inherently homogeneous, or may itself harbour multiple phases, as is known for microphase-separating block copolymers.

An example of a suitable system of analysis for phase separation is scanning electron microscopy. Phase separation may alternatively be recognizable, for example, by the different phases having two mutually independent glass transition temperatures.

Polyacrylate and elastomer components are presently selected such that after intimate mixing they are substantially immiscible at 20° C. (i.e. the customary temperature of use for adhesives). Very preferably the polyacrylate component (P) and the elastomer component (E) are substantially immiscible in a temperature range from 0° C. to 50° C., more preferably from −30° C. to 80° C. “Substantially immiscible” means that either the components cannot be mixed homogeneously with one another at all, so that none of the phases contains a proportion of the second component incorporated homogeneously by mixing, or that the components have only such little, partial compatibility—meaning that one or both components is able to accommodate homogeneously only such a small fraction of the other component—that the partial compatibility is negligible with regard to the invention, in other words is not detrimental to the teaching according to the invention. For the purposes of this specification, the components in question are then regarded as being “substantially free” of the respective other component.

The phase of the polyacrylate component (P) and/or of the elastomer component (E) may take the form of a 100% system, meaning in that case that it contains no components other than the actual polyacrylate component (P) or elastomer component (E), respectively. Aside from the two components (P) and (E), for example, the entire adhesive comprises no further constituents. In an alternative embodiment, one of the, or both, components (P) and (E) contain further admixed components, such as resins, additives or the like, for example.

The polyacrylate component (P) is present preferably in a proportion of 60% to 90% by weight, more preferably 65% to 85% by weight, and the elastomer component (E) is present preferably in a fraction of 10% to 40% by weight, more preferably 15% to 35% by weight, based on the entirety (100% by weight) of the two components (P) and (E).

Phase separation for the inventively employed adhesives occurs in particular such that the elastomer component (E) is present in dispersion in a continuous matrix of the polyacrylate component (P). The regions (domains) formed by the elastomer component (E) are preferably substantially spherical. Other domain shapes are likewise possible—for example, layer shapes or rodlet shapes.

The layer of self-adhesive composition based on an acrylate composition or based on a blend of acrylate and synthetic rubber preferably comprises crosslinkers, typically for crosslinking the acrylate. Crosslinking is carried out in order to obtain desired properties on the part of the self-adhesive composition, such as sufficient cohesion of the self-adhesive composition, for example.

Crosslinkers are compounds—more particularly di—or polyfunctional compounds, usually of low molecular mass—that under the selected crosslinking conditions are able to react with suitable—especially functional—groups in the polymers to be crosslinked, and therefore link two or more polymers or polymer sites to one another (form “bridges”) and hence create a network from the polymer or polymers to be crosslinked. This generally results in an increase in cohesion. The degree of crosslinking is dependent on the number of bridges formed.

Presently, suitable crosslinkers are in principle all crosslinker systems known to the person skilled in the art for the formation in particular of covalent, coordinative or associative bonding systems with correspondingly equipped polyacrylates, depending on the nature of the functional groups present in the polyacrylates. Examples of chemical crosslinking systems are di- or polyfunctional isocyanates, di- or polyfunctional epoxides, di- or polyfunctional hydroxides, di- or polyfunctional amines or di- or polyfunctional acid anhydrides. Combinations of different crosslinkers are also conceivable. Particularly preferred are di- or polyfunctional epoxides; these may be both aromatic and aliphatic compounds, and may also be used in an oligomeric or polymeric form. Further suitable crosslinkers include chelating agents which, in combination with acid functionalities in polymer chains, form complexes which act as crosslinking nodes.

It has proven particularly advantageous to use as crosslinker 0.03 to 0.2 part by weight, more particularly 0.04 to 0.15 part by weight, of N,N,N′,N′-tetrakis(2,3-epoxypropyl)-m-xylene-a,a′-diamine (tetraglycidyl-meta-xylenediamine; CAS 63738-22-7), based on 100 parts by weight of base polyacrylate polymer.

For crosslinking it is of advantage if at least some of the polyacrylates have functional groups which are able to react with the crosslinkers in question. For this purpose, during preparation of the polyacrylates, monomers with functional groups selected from the group encompassing hydroxyl, carboxyl, sulfonic acid or phosphonic acid groups, acid anhydrides, epoxides and amines are preferably used. Particularly preferred examples of monomers for crosslinkable polyacrylates are acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate.

Crosslinkers, however, are not automatically present, one of the reasons for this being the possibility in principle for the polyacrylate to undergo radiation-induced crosslinking as well. Alternatively or additionally to the chemical crosslinking it may be advantageous to carry out radiation-induced crosslinking of the adhesive. Suitable radiation for this purpose includes ultraviolet light (particularly if suitable photoinitiators have been added to the formulation or if at least one polyacrylate includes comonomers having units with photoinitiating functionality) and/or electron beams. For radiation-induced crosslinking it may be an advantage if some of the monomers used when preparing the polyacrylates contain functional groups which support subsequent radiation-induced crosslinking. Suitable copolymerizable photoinitiators are, for example, benzoin acrylate and acrylate-functionalized benzophenone derivatives. Monomers which support crosslinking by electron beams are, for example, tetrahydrofurfuryl acrylate, N-tert-butylacrylamide and allyl acrylate.

The chemical crosslinking may in particular proceed as follows:

In one advantageous procedure, the crosslinker, as the pure material or as a preliminary solution in a suitable solvent, is added to a solution containing the polyacrylate, after which thorough mixing is carried out, and the mixture is subsequently coated onto a liner or carrier and then dried under suitable conditions, with the polyacrylate being crosslinked.

The drying conditions (temperature and residence time) are very preferably selected such that not only is the solvent removed but also the crosslinking is concluded to a large degree, so that a stable level of crosslinking—even at relatively high usage temperatures—is achieved as early as during drying. After the drying, as for example during subsequent foaming and/or storage, the adhesive frequently undergoes further crosslinking.

The self-adhesive composition layers of the invention based on an acrylate composition or on a blend of acrylate and synthetic rubber further comprise expandable microballoons and optionally further constituents such as, in particular, tackifying resins and/or additives. With regard to the nature and amount of the microballoons and any further constituents, the observations made in relation to the self-adhesive composition layers based on a vinylaromatic block copolymer composition are valid analogously.

The foamable self-adhesive composition layer comprising expandable microballoons and used in the method of the invention is customarily prepared from solution.

In a typical method for producing the foamable layer of self-adhesive composition, the constituents of the adhesive, such as the base polymer/base polymers and optionally further components such as tackifying resin, ageing inhibitor, plasticizer, flame retardant and/or crosslinker, are dissolved in a solvent (mixture) such as, for example, benzine/toluene/acetone, benzine/acetone or benzine. It is usual here to use a kneading apparatus, stirrer, roller bed or similar commercial mixing apparatus. In one embodiment here the base polymer may actually be provided in the form of a solution in the solvent (mixture) in which it was prepared. For example, a polyacrylate may already be used in the form of a solution in benzine/acetone. The expandable microballoons are suspended, in benzine or benzine/acetone, for example, and are incorporated by stirring into the solution of adhesive, to form a homogeneous foamable self-adhesive composition. To prevent the development of agglomerated microballoons, care is taken to ensure that during suspension the expandable microballoons are completely wetted by a solvent. As soon as the microballoons are homogeneously distributed in the solution, the self-adhesive composition can be coated onto a liner suitable for use in the method of the invention, more particularly onto a double-sidedly siliconized PET liner with a thickness of 50 to 75 μm. A variety of coating systems according to the prior art may be used. For example, coating may take place using a (comma) bar, a coating bar or a nozzle.

In the next step, the adhesive applied by coating is dried at a temperature at which there is still no onset of microballoon expansion, and is optionally crosslinked. The onset temperature needed for expansion is dependent on the microballoon type and may be between 75 to 220° C. For example, drying takes place in a drying oven at 100° C. for 15 minutes. Alternatively, in the drying step, the adhesive may also pass through a temperature programme, typically involving the adhesive travelling through a drying tunnel with a plurality of heating zones at different temperatures (from 30 to 120° C., for example) with a belt speed, for example, of 15 m/min. A drying tunnel of this kind may comprise, for example, a drying tunnel having seven heating zones and a cooling zone, with a length of 3 m per zone. For optimum drying, the temperature maximum here is typically set just below the onset temperature needed for the expansion of the microballoons. In none of the aforesaid steps, therefore, is there any expansion of the microballoons.

The open side of the dried layer of self-adhesive composition is subsequently lined with a further liner suitable for use in the method of the invention. This produces a transfer tape.

Alternatively, a single-sided adhesive tape can be provided by using a carrier rather than the liner onto which the self-adhesive composition is coated or the liner with which the open side of the dried layer of self-adhesive composition is lined.

If, prior to foaming, a second, likewise dried foamable layer of self-adhesive composition comprising expandable microballoons, applied in turn to a liner suitable for use in the method of the invention, is applied to the surface of the carrier of the single-sided adhesive tape, the result is a three-layer product made up of an inner carrier and two foamable self-adhesive layers which are in direct contact with the carrier and comprise expandable microballoons, and which are provided in turn with liners on their outer faces. This product is a double-sided, carrier-containing adhesive tape. The second foamable layer of self-adhesive composition may be produced in the same way as the first foamable layer of self-adhesive composition.

A three-layer construction of this kind may alternatively be provided by coating the carrier simultaneously or in succession directly with the foamable self-adhesive compositions comprising expandable microballoons, after which the layers of self-adhesive composition are dried, at 100° C., for 15 minutes, for example, and then lined with liners suitable for use in the method of the invention.

The foamable layer or layers of self-adhesive composition disposed between the liners and/or carriers are subsequently heat-treated at a temperature suitable for foaming for a period of time such that the desired degree of foaming is achieved after the subsequent cooling of the layer or layers. The liners in this case are selected, as already explained above, in such a way that they remain adhering substantially completely on the respective surface of the foamable layer or layers of self-adhesive composition on which they are disposed, during the foaming. This results in layers of self-adhesive composition that are at least partially foamed with microballoons.

As already described above, the foamable layer of self-adhesive composition may alternatively be disposed between a liner and a further layer of self-adhesive composition, by applying a self-adhesive composition comprising expandable microballoons from a solution to a liner and drying it below the foaming temperature, and laminating a further layer of self-adhesive composition, applied to a liner or carrier, to that surface of the dried, foamable layer of self-adhesive composition that is opposite the liner. The further layer of self-adhesive composition may be foamable or non-foamable; if foamable, it preferably comprises expandable microballoons. The result is a foamable transfer tape or foamable single-sided adhesive tape. If a foamable layer of self-adhesive composition which has been dried and is disposed on a liner is laminated onto both sides of a carrier, on both sides of which there is in turn in each case one further layer of self-adhesive composition disposed, then the product is also a foamable, double-sided adhesive tape with carrier, i.e. carrier-containing adhesive tape. The subsequent expansion to the desired degree of foaming, as described above, yields the corresponding foamed adhesive tape.

The energy needed for the foaming is transferred in accordance with the invention preferably by convection, radiation such as (N)IR or UV radiation, or by heat conduction, to the assembly made up of foamable self-adhesive composition layer, liner and optionally carrier and/or further self-adhesive composition layer.

In particular, the energy needed for foaming may be transferred by heat conduction uniformly over the web width to the assembly, by means of one or more heated rolls, for example. In one particularly preferred embodiment, a sequence of at least two heated rolls is used here, with the assembly being passed over the at least two rolls in such a way that the surfaces of the assembly are in reciprocal contact with the roll surfaces. In this case the distance between the rolls is always greater than the thickness of the assembly, and more particularly no roll pair exerts pressure on the assembly.

For foaming, alternatively, it is possible to use a drying oven or drying tunnel. The drying tunnel in this case may have a construction, for example, as described above for the drying. In the case of foaming in the drying tunnel, the term “tunnel foaming” is also used.

The appropriate foaming temperature is dependent on the type of microballoon used. As explained above, the onset temperature required for expansion may, in dependence on the type of microballoon used, be between 75 to 220° C. For example, the foaming temperature is 10 to 50° C. above the onset temperature required for the expansion of the type of microballoon being used. Typical foaming temperatures are in the range from 130 to 180° C., such as 160 to 170° C., for example. Another factor determining the degree of foaming, apart from the foaming temperature, is the foaming time. A typical foaming time is in the range from 10 to 60 s. If the aforementioned drying tunnel is used for foaming, the temperature programme of the seven heating zones, starting with 40° C., for example, may go via 90° C. with 2 zones at 140° C. and then up to 170° C. for 3 zones. Typical belt speeds are in the range from 30 m/min to 100 m/min.

### FIGURES

On the basis of the figures described below, particularly advantageous embodiments of the invention are elucidated in more detail, without the intention thereby to subject the invention to unnecessary limitation.

FIG. 1 shows the schematic construction of a double-sided, carrier-containing adhesive tape of the invention, in cross section.

The adhesive tape comprises a carrier 1. On the top side and on the bottom side of the carrier 1 there are two self-adhesive composition layers 2, 3 at least partially foamed with microballoons. The self-adhesive composition layers 2, 3 are in turn each lined with a liner 4, 5 suitable for use in the method of the invention such as, for example, with a double-sidedly siliconized PET liner in a thickness of 75 μm.

FIG. 2, furthermore, shows the schematic construction of a transfer tape of the invention, in cross section.

The adhesive tape (transfer tape) comprises a self-adhesive composition layer 2 at least partially foamed with microballoons. The self-adhesive composition layer 2 is lined on both sides with a liner 4, 5 suitable for use in the method of the invention, such as, for example, with a double-sidedly siliconized PET liner in a thickness of 75 μm.

FIG. 3 shows the schematic construction of a further transfer tape of the invention, in cross section.

The adhesive tape (transfer tape) comprises two self-adhesive composition layers 2 and 3 at least partially foamed with microballoons, the layers being preferably identical in chemical nature, and being disposed one above the other, i.e. in direct contact with one another. On the open side, the self-adhesive layers 2 and 3 are each lined with a liner 4, 5 suitable for use in the method of the invention, such as, for example, with a double-sidedly siliconized PET liner in a thickness of 75 μm.

FIG. 4 shows the schematic construction of a further transfer tape of the invention, in cross section.

The adhesive tape (transfer tape) comprises one self-adhesive composition layer 2 at least partially foamed with microballoons, and one unfoamed self-adhesive composition layer 6, these layers being disposed one above the other, i.e. in direct contact with one another. On the open side, the self-adhesive composition layers 2 and 6 are each lined with a liner 4, 5 suitable for use in the method of the invention, such as, for example, with a double-sidedly siliconized PET liner in a thickness of 75 μm.

FIG. 5 shows a SEM micrograph (300-fold magnification) of a cryofracture edge of the polyacrylate-based self-adhesive composition layer from Example 1, foamed in accordance with the invention between two double-sidedly siliconized PET liners each with a thickness of 75 μm. The surface of the self-adhesive composition layer is smooth. In particular, no foamed microballoons are projecting from the self-adhesive composition layer. During foaming, therefore, the microballoons remain in the self-adhesive composition layer, i.e. are not pressed out of this layer.

FIG. 6 shows an SEM micrograph (300-fold magnification) of a cryofracture edge of the polyacrylate-based self-adhesive composition layer from comparative Example 4, foamed between two liners in the form of release papers with a thickness of 77 μm each. During foaming in the drying oven, the release paper lifted on one side from the self-adhesive composition layer (and is consequently no longer visible in the micrograph). On the then open side of the self-adhesive composition layer, the expanding microballoons were subsequently pressed out of the composition. Accordingly, foamed microballoons which project from the self-adhesive composition layer are visible, and which make the open side of the self-adhesive composition layer uneven.

FIG. 7 shows an SEM micrograph (50-fold magnification) of a cryofracture edge of the polyacrylate-based self-adhesive composition layer from comparative Example 5, foamed between two HDPE liners each with a thickness of 100 μm. During the foaming of the self-adhesive composition layer in the drying oven, the HDPE liners were not temperature-stable. One of the HDPE liners took on a wave shape, in other words lost its flat lie. Thereupon the self-adhesive composition layer detached, partially at any rate, from the respective liner on both sides. As can additionally be seen from the micrograph, the self-adhesive composition layer after foaming is uneven and occasionally in fact wavy.

FIG. 8 shows an exemplary web pathway for foaming by roll contact. It employs a sequence of five heated rolls 7. The assembly 8, made up of foamable self-adhesive composition layer, liner and optionally carrier and/or further self-adhesive composition layer, is guided over the rolls 7 in such a way that the surfaces of the assembly 8 are in reciprocal contact with the roll surfaces.

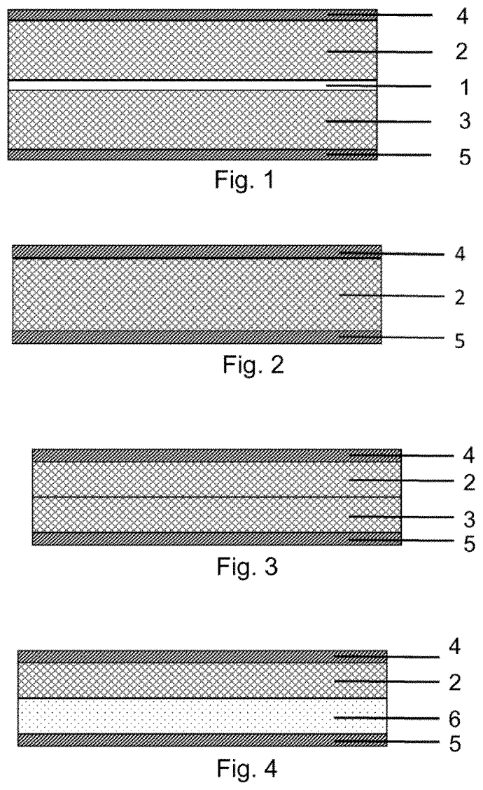

The invention is elucidated in more detail below by means of a number of examples. Particularly advantageous embodiments of the invention are elucidated in more detail using the examples described below, without thereby wishing to subject the invention to any unnecessary limitation.

### EXAMPLES

Described below are exemplary methods for producing a layer of self-adhesive composition foamed with microballoons, for which the foaming takes place in each case between two liners.

### Inventive Example 1

In the first step, the base polymer P1, i.e. the polyacrylate (Ac), envisaged for use in the self-adhesive composition was prepared via a free radical polymerization in solution. A reactor conventional for radical polymerizations was charged here with 60 kg of 2-ethylhexyl acrylate, 33 kg of n-butyl acrylate, 7 kg of acrylic acid and 66 kg of benzine/acetone (70/30). After nitrogen gas had been passed through the reactor for 45 minutes with stirring, the reactor was heated up to 58° C. and 50 g of AIBN were added. Thereafter the external heating bath was heated to 75° C. and the reaction was carried out constantly at this external temperature. After 1 hour a further 50 g of AIBN were added and after 4 hours dilution took place with 20 kg of benzine/acetone mixture. After 5.5 hours and again after 7 hours, reinitiation took place with in each case 150 g of bis(4-tert-butylcyclohexyl) peroxydicarbonate. After a reaction time of 22 hours, the polymerization was terminated and cooling took place to room temperature (20° C.). The polyacrylate has an average molecular weight of M_{w}=450 000 g/mol and a polydispersity PD (M_{w}/Mₙ)=7.8.

Subsequently, the foamable self-adhesive composition was prepared. For this purpose, 100 wt % of the base polymer P1 were adjusted by the addition of benzine and acetone (in a weight ratio of 1:1) to a solids content of 35 wt %. Thereafter 2.5 wt % of unexpanded microballoons of type Expancel 920 DU20 were added to the composition as a mixture in benzine/acetone (weight ratio 1:1) at room temperature (20° C.) and with stirring. The weight fractions of the microballoons in the examples are based in each case on the dry weight of the solution to which they were added (i.e. the dry weight of the solution used is set as 100%). The mixture was stirred for 15 minutes, after which 0.075 wt % of the covalent crosslinker Erysis GA 240 (N,N,N′,N′-tetrakis(2,3-epoxypropyl)-m-xylene-a,a′-diamine) from Emerald Performance Materials was added with stirring, based on the weight of the base polymer used. The mixture was stirred for a further 15 minutes.

The resulting mixture was then mixed continuously with a stirrer, pumped through a 50 μm filter, again mixed using a static mixer, and finally conveyed to the coating table, where a comma bar was used for application, at a web speed of 15 m/min to a PET liner (Inventive Example 1) 75 μm thick and furnished on each side with a releasing silicone (silicone coatweight: 1 g/m² on both sides), of a layer whose thickness was such as to give a coatweight of 85 g/m² following subsequent evaporation of the solvent at 100° C. for 15 minutes in a drying oven and hence drying of the layer of composition.

A second, identical PET liner was then laminated onto the free surface of the layer of self-adhesive composition produced and dried, and the self-adhesive composition layer was subsequently foamed between the two liners in a drying oven at 163° C. for 30 seconds and then cooled at room temperature (20° C.).

During foaming, the liners remained adhering completely to the respective surface of the foamable self-adhesive composition layer on which they were disposed. The shrinkage of the liners during foaming was 0% in both longitudinal and transverse directions; in other words, there was no shrinkage found either in transverse or in longitudinal direction. Furthermore, during foaming, the liners were weight-stable, i.e. did not lose weight. Moreover, during the foaming, the liners consistently adopted a flat lie.

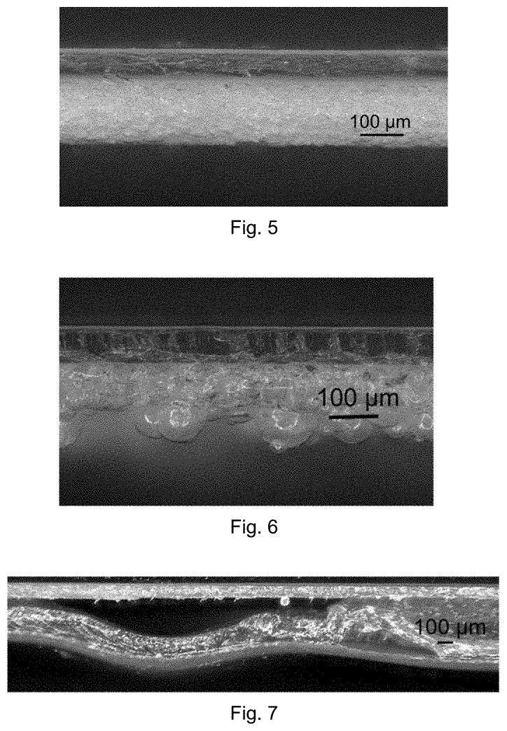

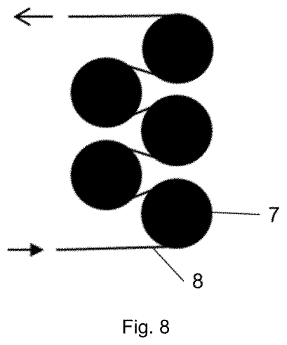

As shown by the SEM micrograph from FIG. 5, the surface of the self-adhesive composition layer is smooth. In particular, no foamed microballoons project from the self-adhesive composition layer. Accordingly, the microballoons remained in the self-adhesive composition layer during foaming, i.e. were not pressed out of this layer. The surface roughness Rₐ of the foamed self-adhesive composition layer is 2.5 μm.

### Inventive Example 2

The method for producing a self-adhesive composition layer foamed with microballoons corresponds to Inventive Example 1, with the two double-sidedly siliconized PET liners used having a thickness of only 50 μm.

During foaming, the liners remained adhering completely to the respective surface of the foamable self-adhesive composition layer on which they were disposed. The shrinkage of the liners during foaming was 0% in both longitudinal and transverse directions; in other words, there was no shrinkage found either in transverse or in longitudinal direction. Furthermore, during foaming, the liners were weight-stable, i.e. did not lose weight. Moreover, during the foaming, the liners consistently adopted a flat lie.

In SEM micrographs, a smooth surface can be seen for the self-adhesive composition layer. In particular, no foamed microballoons project from the self-adhesive composition layer. Accordingly, the microballoons remained in the self-adhesive composition layer during foaming, i.e. were not pressed out of this layer (not shown). The surface roughness Rₐ of the foamed self-adhesive composition layer is 1.8 μm.

### Comparative Example 3

The method for producing a self-adhesive composition layer foamed with microballoons corresponds to Inventive Example 1, with the two double-sidedly siliconized PET liners used having a thickness of only 12 μm.

During foaming, the liners lost their flat lie. The foaming operation led to shrinkage of the liners by in each case 2% in longitudinal and transverse directions. During the foaming, therefore, the liners did not remain adhering completely to the respective surface of the foamable self-adhesive composition layer on which they were disposed. The suitability of a liner for the method of the invention is therefore dependent not merely on the liner material but also on the liner thickness. At those locations where the liners lifted, microballoons emerged from the surface of the adhesive composition, and the surface of the adhesive composition was matt and rough.

### Comparative Example 4

The method for producing a layer of self-adhesive composition foamed with microballoons corresponds to Inventive Example 1, with the two liners used each comprising a release paper (TP) with a thickness of 77 μm in each case.

During foaming, the liners were not weight-stable, instead losing around 2 wt % through loss of moisture. One of the release papers lifted from the self-adhesive composition layer during foaming in the drying oven. On the then open side of the self-adhesive composition layer, the expanding microballoons were subsequently pressed out of the composition. In an SEM micrograph, accordingly, foamed microballoons are visible, projecting from the self-adhesive composition layer, which make the open side of the self-adhesive composition layer uneven (see FIG. 6). Moreover, foaming resulted in shrinkage of the liners by 1% in the longitudinal direction and 0% in the transverse direction.

### Comparative Example 5

The method for producing a layer of self-adhesive composition foamed with microballoons corresponds to Example 1, with the two liners used each comprising an HDPE liner with a thickness of 100 μm.

During the foaming of the self-adhesive composition layer, the liners melted, owing to the low melting temperature of polyethylene. As can be seen from the SEM micrograph from FIG. 7, one of the HDPE liners adopted a wavy shape, i.e. lost its flat lie (additionally, the liner shrank by 74% in the longitudinal direction and 0% in the transverse direction). Thereafter the self-adhesive composition layer underwent at least partial detachment from the respective liner on both sides. As can also be seen from the micrograph, the self-adhesive composition layer after foaming is uneven and occasionally in fact is wavy.

### Comparative Example 6

The method for producing a layer of self-adhesive composition foamed with microballoons corresponds to Example 1, with the two liners used each comprising paper (TP) coated double-sidedly with polyethylene (PE).

During the foaming of the self-adhesive composition layer, the polyethylene layers of the liners melted, owing to the low melting temperature of polyethylene. When viewed with the naked eye after foaming, therefore, the liners appeared blistery and matt. One of the liners adopted a wavy shape during foaming, i.e. lost its flat lie (additionally, the liner shrank by 1% in the longitudinal direction and 0% in the transverse direction). Thereafter the self-adhesive composition layer underwent at least partial detachment from the liner on both sides. After foaming, the self-adhesive composition layer was uneven and occasionally in fact was wavy.

### Inventive Example 7

An inventive pressure-sensitive adhesive strip was produced on the basis of a styrene block copolymer (SBC) composition.

For this purpose, first, a 40 wt % strength adhesive solution in benzine/toluene/acetone was prepared from 48.0 wt % of Kraton D1102AS, 48.0 wt % of Piccolyte A115, 3.5 wt % of Wingtack 10 and 0.5 wt % of ageing inhibitor Irganox 1010 (also called adhesive solution 1). The weight fractions of the dissolved constituents here are based in each case on the dry weight of the resulting solution. The stated constituents of the adhesive are characterized as follows:
Kraton D1102AS: styrene-butadiene-styrene triblock copolymer from Kraton Polymers with 17 wt % diblock, block polystyrene content: 30 wt %
Piccolyte A115: solid α-pinene tackifying resin having a Ring & Ball softening temperature of 115° C.
Wingtack 10: liquid hydrocarbon resin from Cray Valley
Irganox 1010: pentaerythritol tetrakis(3-(3,5-di-tert-butyl-4-hydroxy-phenyl)propionate) from BASF SE

The solution was subsequently admixed with 3.3 wt % of Expancel 920 DU20 unexpanded microballoons, the microballoons being used in the form of a suspension in benzine. The weight fractions of the microballoons in the examples are based in each case on the dry weight of the solution used to which they were added (i.e. the dry weight of the solution used is set as 100%). The resulting mixture was then applied with a coating bar to a 75 μm PET liner as defined in Example 1, in a layer thickness such as to result in a coatweight of 75 g/m² following subsequent evaporation of the solvent at 100° C. for 15 minutes and therefore drying of the layer of composition.

Subsequently a second such PET liner was laminated onto the free surface of the layer of adhesive composition produced and dried, after which the layer of adhesive composition was foamed between the two liners in the oven at 163° C. for 30 seconds and then cooled at room temperature (20° C.).

During foaming, the liners remained adhering completely to the respective surface of the foamable self-adhesive composition layer on which they were disposed. The shrinkage of the liners during foaming was 0% in both longitudinal and transverse directions; in other words, there was no shrinkage found either in transverse or in longitudinal direction. Furthermore, during foaming, the liners were weight-stable, i.e. did not lose weight. Moreover, during the foaming, the liners consistently adopted a flat lie.

The surface of the self-adhesive composition layer is smooth. In particular, no foamed microballoons project from the self-adhesive composition layer. Accordingly, the microballoons remained in the self-adhesive composition layer during foaming, i.e. were not pressed out of this layer. The surface roughness Rₐ of the foamed self-adhesive composition layer is 2.1 μm.

### Inventive Example 8

An inventive pressure-sensitive adhesive strip was produced on the basis of a polyacrylate (Ac)-styrene block copolymer (SBC) blend.

For this purpose a mixture was prepared comprising 42.425 wt % of base polymer P1 as described above in Inventive Example 1, 37.5 wt % of Dertophene T resin and also 20 wt % of Kraton D 1118. Dertophene T is a terpene-phenolic resin (softening point 110° C.; M_{w}=500 to 800 g/mol; PD=1.50) from DRT resins. Kraton 1118 is a styrene-butadiene-styrene block copolymer from Kraton Polymers with 78 wt % of 3-block, 22 wt % of 2-block, a block polystyrene content of 33 wt %, and a molecular weight M_{w} of 150 000 g/mol for the 3-block fraction. Benzine was added to set a solids content of 38 wt %. The mixture of polymer and resin was stirred until the resin had visibly dissolved entirely. Then 0.075 wt % of the covalent crosslinker Erysis GA 240 (N,N,N′,N′-tetrakis(2,3-epoxypropyl)-m-xylene-a,a′-diamine) from Emerald Performance Materials was added. The weight fractions of the dissolved constituents are based in each case on the dry weight of the resulting solution. The mixture was stirred for 15 minutes with addition of 0.8 wt % of Expancel 920 DU20 unexpanded microballoons at room temperature (20° C.). The resulting mixture was then applied with a coating bar to a 75 μm PET liner as defined in Example 1, in a layer thickness such as to result in a coatweight of 130 g/m² following subsequent evaporation of the solvent at 100° C. for 15 minutes and therefore drying of the layer of composition.

Subsequently a second such PET liner was laminated onto the free surface of the layer of adhesive composition produced and dried, after which the layer of adhesive composition was foamed between the two liners in the oven at 163° C. for 30 seconds and then cooled at room temperature (20° C.).

During foaming, the liners remained adhering completely to the respective surface of the foamable self-adhesive composition layer on which they were disposed. The shrinkage of the liners during foaming was 0% in both longitudinal and transverse directions; in other words, there was no shrinkage found either in transverse or in longitudinal direction. Furthermore, during foaming, the liners were weight-stable, i.e. did not lose weight. Moreover, during the foaming, the liners consistently adopted a flat lie.

The surface of the self-adhesive composition layer is smooth. In particular, no foamed microballoons project from the self-adhesive composition layer. Accordingly, the microballoons remained in the self-adhesive composition layer during foaming, i.e. were not pressed out of this layer. The surface roughness Rₐ of the foamed self-adhesive composition layer is 2.9 μm.

Table 1 shows various properties of the microballoon-foamed self-adhesive composition layers from the inventive examples and comparative examples.

| | Liner | | | | | Peel | |
|---|---|---|---|---|---|---|---|
| | type and | Base | Thickness* | Density* | | adhesion* | Dupont z* |
| Example | thickness | polymer | [μm] | [kg/m³] | Rₐ* [μm] | [N/cm] | [J] |
| 1 | PET, | Ac | 130 | 650 | 2.5 | 7 | 0.7 |
| | 75 μm | | | | | | |
| 2 | PET, | Ac | 130 | 650 | 1.8 | 7 | 0.7 |
| | 50 μm | | | | | | |
| C3 | PET, | Ac | 130 | 650 | 8 | 4 | 0.21 |
| | 12 μm | | | | | | |
| C4 | TP, | Ac | 130 | 650 | 11 | 4 | 0.15 |
| | 77 μm | | | | | | |
| C5 | HDPE, | Ac | 130 | 650 | not | not | not |
| | 77 μm | | | | measurable, | measurable | measurable |
| | | | | | i.e. >75 μm | | |
| C6 | PE TP, | Ac | 130 | 650 | not | not | not |
| | 100 μm | | | | measurable, | measurable | measurable |
| | | | | | i.e. >75 μm | | |
| 7 | PET, | SBC | 145 | 520 | 2.1 | 8 | 0.62 |
| | 75 μm | | | | | | |
| 8 | PET, | Ac/SBC | 150 | 880 | 2.9 | 11 | 0.8 |
| | 75 μm | | | | | | |

*pertains to the foamed self-adhesive composition layer.

The foamed self-adhesive composition layers from the inventive examples, produced using in each case an inventively suitable liner, are smooth, having in each case a surface roughness Rₐ of less than 3 μm. As the Dupont z values show, they also have high penetration toughness. In addition they possess very good peel adhesions. As shown by Examples 1, 7 and 8, this is the case for various base polymers.

The foamed self-adhesive composition layers from the comparative examples, conversely, have much higher surface roughnesses Rₐ, and also significantly lower penetration resistance and peel adhesion on steel (or else the self-adhesive compositions are so poor in relation to the stated physical parameters that they cannot be measured). The comparative examples show that the inventive suitability of the liner is influenced not only by the nature of the liner material but also by the thickness of the liner.

### Test Methods

Unless stated otherwise, all measurements were conducted at 23° C. and 50% rel. air humidity.

The mechanical and technical adhesive data were ascertained as follows:

### Tensile Strength, Tear Strength (Tear Force) and Elongation at Break (Measurement Method R1)

The elongation at break, the tear strength and the tensile strength, of a film carrier, for example, were measured in accordance with DIN EN ISO 527-3:2003-07 using a sample strip, specimen type 2, having a width of 20 mm, at a separation speed of 100 mm per minute. The initial distance between the clamping jaws was 100 mm. The test conditions were 23° C. and 50% rel. air humidity.

### Detachment Force

The detachment force (stripping force or stripping strain) was ascertained using a pressure-sensitive adhesive strip having dimensions of 50 mm length×20 mm width with a non-adhesive grip tab region at the upper end. The pressure-sensitive adhesive strip was adhered between two steel plates, disposed congruently to one another, having dimensions of 50 mm×30 mm, adhesion taking place with a pressing pressure of 50 newtons in each case. At their lower end, the steel plates each have a drilled hole for accommodating an S-shaped steel hook. The lower end of the steel hook carries a further steel plate, via which the test set-up can be fixed for measurement in the lower clamping jaw of a tensile testing machine. The bonds were stored for a time of 24 hours at +40° C. After reconditioning to room temperature (20° C.), the pressure-sensitive adhesive strip was removed with a pulling speed of 1000 mm per minute, parallel to the bond plane and without contact with the edge regions of the two steel plates. During this operation, the required detachment force was measured, in newtons (N). The figure reported is the mean of the stripping strain values (in N per mm²), measured in the range in which the adhesive strip is detached from the steel substrates over a bond length of between 10 mm and 40 mm.

### Peel Adhesion

The peel adhesion was determined (in accordance with AFERA 5001) as follows: The defined substrate used was galvanized steel plate having a thickness of 2 mm (acquired from Rocholl GmbH). The pressure-sensitive adhesive strip under investigation was cut to a width of 20 mm and a length of about 25 cm, provided with a handling section, and immediately thereafter pressed five times onto the selected substrate using a 4 kg steel roller with a rate of advance of 10 m/min. Directly after that, the adhesive strip was pulled from the substrate at an angle of 180° using a tensile testing apparatus (from Zwick) at a velocity v=300 mm/min, and a measurement was made of the force required to achieve this at room temperature (20° C.). The measurement value (in N/cm) is obtained as the mean value from three individual measurements.

### Thickness

The thickness, for example, of a pressure-sensitive adhesive strip, of an adhesive composition layer or of a carrier layer can be determined by means of commercial thickness measuring instruments (calliper test instruments) with accuracies of less than 1 μm deviation. The thickness of an adhesive composition layer is ascertained typically by determining the thickness of a section, defined in terms of its length and width, of such a layer applied to a carrier or liner, minus the (known or separately determinable) thickness of a section of the same dimensions of the carrier or liner used. If variations in thickness are found, the mean of measurements at not less than three representative sites is reported, i.e. more particularly not measured at creases, folds, specks and the like. In the present specification, thickness is measured using the Mod. 2000 F precision thickness measuring instrument, which has a circular probe with a diameter of 10 mm (flat). The measuring force is 4 N. The value is read off 1 s after loading.

### Density

The density of an adhesive composition layer is ascertained by forming the quotient of coatweight and thickness of the adhesive composition layer applied to a carrier or liner.

The coatweight of an adhesive composition layer can be determined by determining the mass of a section, defined in terms of its length and width, of such a layer applied to a carrier or liner, minus the (known or separately determinable) mass of a section of the same dimensions of the carrier or liner used.

The thickness of an adhesive composition layer can be determined by determining the thickness of a section, defined in terms of its length and width, of such a layer applied to a carrier or liner, minus the (known or separately determinable) thickness of a section of the same dimensions of the carrier or liner used. The thickness of the layer can be determined by means of commercial thickness measuring instruments (calliper test instruments) with accuracies of less than 1 μm deviation. If variations in thickness are found, the mean of measurements at not less than three representative sites is reported, i.e. more particularly not measured at creases, folds, specks and the like. In the present specification, thickness is measured using the Mod. 2000 F precision thickness measuring instrument, which has a circular probe with a diameter of 10 mm (flat). The measuring force is 4 N. The value is read off 1 s after loading.

### DuPont Test in the z Direction (Penetration Resistance)

A square sample in the shape of a frame was cut out of the adhesive tape (pressure-sensitive adhesive strip) to be examined (external dimensions 33 mm×33 mm; border width 2.0 mm; internal dimensions (window cut-out) 29 mm×29 mm). This sample was stuck to a PC frame (external dimensions 45 mm×45 mm; border width 10 mm; internal dimensions (window cutout) 25 mm×25 mm; thickness 3 mm). A PC window of 35 mm×35 mm was stuck to the other side of the adhesive tape. The bonding of PC frame, adhesive tape frame and PC window was carried out such that the geometric centres and the diagonals were each superimposed on one another (corner-to-corner). The bonding area was 248 mm². The bond was subjected to a pressure of 248 N for 5 s and stored under conditions of 23° C./50% relative humidity for 24 hours. Immediately after the storage, the adhesive assembly composed of PC frame, adhesive tape and PC window was braced by the protruding edges of the PC frame in a sample holder such that the assembly was aligned horizontally and the PC window was beneath the frame. The sample holder was then inserted centrally into the intended receptacle of the DuPont Impact Tester. The impact head of weight 190 g was used in such a way that the circular impact geometry with the diameter of 20 mm impacted centrally and flush on the window side of the PC window.

A weight having a mass of 150 g, guided on two guide rods, was allowed to drop vertically from a height of 5 cm onto the assembly thus arranged and composed of sample holder, sample and impact head (measuring conditions: 23° C., 50% relative humidity). The height from which the weight dropped was increased in 5 cm steps until the impact energy introduced destroyed the sample as a result of the impact stress, and the PC window parted from the PC frame.

In order to be able to compare experiments with different samples, the energy was calculated as follows:

E[J]=height [m]*weight [kg]*9.81 m/s²

Five samples per product were tested, and the mean energy was reported as the index of penetration resistance.

### Diameter

The mean diameter of the voids formed by the microballoons in a self-adhesive composition layer is determined using cryofracture edges of the pressure-sensitive adhesive strip in a scanning electron microscope (SEM) with 500-fold magnification. The diameter of the microballoons in the self-adhesive composition layer to be examined that are visible in SEM micrographs of five different cryofracture edges of the pressure-sensitive adhesive strip is determined in each case by graphical means, and the arithmetic mean of all the diameters ascertained in the five SEM micrographs constitutes the mean diameter of the voids formed by the microballoons in the self-adhesive composition layer in the context of the present application. The diameters of the microballoons visible in the micrographs are determined by graphical means in such a way that the maximum extent in any (two-dimensional) direction is inferred from the SEM micrographs for each individual microballoon in the self-adhesive composition layer to be examined, and is regarded as the diameter thereof.

### Static Glass Transition Temperature T_{g}

Glass transition points—referred to synonymously as glass transition temperatures—are reported as the result of measurements by means of Dynamic Scanning calorimetry (DSC) in accordance with DIN 53765:1994-03, especially sections 7.1 and 8.1, but with uniform heating and cooling rates of 10 K/min in all heating and cooling steps (compare DIN 53765:1994-03; section 7.1; note 1). The sample mass is 20 mg.

### DACP

5.0 g of test substance (the tackifier resin sample to be examined) are weighed into a dry test tube, and 5.0 g of xylene (isomer mixture, CAS [1330-20-7], 98.5%, Sigma-Aldrich #320579 or comparable) are added. The test substance is dissolved at 130° C. and then cooled down to 80° C. Any xylene that escapes is made up for with fresh xylene, such that 5.0 g of xylene are present again. Subsequently, 5.0 g of diacetone alcohol (4-hydroxy-4-methyl-2-pentanone, CAS [123-42-2], 99%, Aldrich #H41544 or comparable) are added. The test tube is shaken until the test substance is dissolved completely. For this purpose, the solution is heated to 100° C. The test tube containing the resin solution is then introduced into a Novomatics Chemotronic Cool cloud point measuring instrument and heated therein to 110° C. It is cooled down at a cooling rate of 1.0 K/min. The cloud point is detected optically. For this purpose, the temperature recorded is that at which the turbidity of the solution is 70%. The result is reported in ° C. The lower the DACP value, the higher the polarity of the test substance.

### MMAP

5.0 g of test substance (the tackifier resin sample to be examined) are weighed into a dry test tube, and 10 ml of dry aniline (CAS [62-53-3], 99.5%, Sigma-Aldrich #51788 or comparable) and 5 ml of dry methylcyclohexane (CAS [108-87-2], 99%, Sigma-Aldrich #300306 or comparable) are added. The test tube is shaken until the test substance is dissolved completely. For this purpose, the solution is heated to 100° C. The test tube containing the resin solution is then introduced into a Novomatics Chemotronic Cool cloud point measuring instrument and heated therein to 110° C. It is cooled down at a cooling rate of 1.0 K/min. The cloud point is detected optically. For this purpose, the temperature recorded is that at which the turbidity of the solution is 70%. The result is reported in ° C. The lower the MMAP value, the higher the aromaticity of the test substance.

### Softening Temperature

The determination of softening temperature, such as of tackifying resins, polymers or polymer blocks, for example, is conducted by the relevant methodology, known as Ring & Ball and standardized in ASTM E28-14.

### Gel Permeation Chromatography (GPC)

Mₙ, M_{w}, PD: the data for number-average molar mass Mₙ, for weight-average molecular weight M_{w} and the polydispersity PD are based on determination by gel permeation chromatography. The determination is made on 100 μL of sample having undergone clarifying filtration (sample concentration 1 g/L). The eluent used is tetrahydrofuran with 0.1% by volume of trifluoroacetic acid. Measurement takes place at 25° C. The pre-column used is a column type PSS-SDV, 5μ, 10³ Å, ID 8.0 mm×50 mm. Separation takes place using the columns of type PSS-SDV, 5μ, 10³ Å and also 10⁵ Å and 10⁶ Å each of ID 8.0 mm×300 mm (columns from Polymer Standards Service; detection using Shodex RI71 differential refractometer). The flow rate is 1.0 ml per minute. Calibration takes place against PMMA standard (polymethyl methacrylate calibration) and/or against polystyrene in the case of (synthetic) rubbers.

### Resilience or Elasticity

To measure the resilience, the film carriers were extended by 100%, kept at this extension for 30 s and then released. After a wait time of 1 min, the length was measured again.

The resilience is then calculated as follows:

R=((L₁₀₀−L_{end})/L₀)*100

where R=resilience in %
L₁₀₀: Length of the film carrier after extension by 100%
L₀: Length of the film carrier prior to extension
L_{end}: Length of the film carrier after relaxation for 1 min.

The resilience here corresponds to the elasticity.

### Modulus of Elasticity

The modulus of elasticity indicates the mechanical resistance that a material offers to elastic deformation. It is determined as the ratio of the strain σ required to the elongation c achieved, where c is the quotient of the change in length ΔL and the length L₀ in Hooke's regime of deformation of the test specimen. The definition of the modulus of elasticity is elucidated, for example, in Taschenbuch der Physik (H. Stöcker (ed.), Taschenbuch der Physik, 2nd edn., 1994, Verlag Harri Deutsch, Frankfurt, pp. 102-110).

To determine the modulus of elasticity of a film, the tensile strain characteristics were ascertained using a type 2 specimen (rectangular film test strip of length 150 mm and width 15 mm) according to DIN EN ISO 527-3:2003-07 with a test speed of 300 mm/min, a clamping length of 100 mm and an initial force of 0.3 N/cm, the test strip, for ascertainment of the data, having been cut to size using sharp blades. A Zwick tensile testing machine (model Z010) was employed. Tensile strain characteristics were measured in machine direction (MD). A 1000 N (Zwick Roell Kap-Z 066080.03.00) or 100 N (Zwick Roell Kap-Z 066110.03.00) load cell was used. The modulus of elasticity was ascertained by graphical means from the measurement curves by determining the slope of the starting region of the curve which is characteristic of the behaviour in respect of Hooke's law, and was reported in GPa.

### Surface Roughness Rₐ

The surface roughness Rₐ was determined by laser triangulation.

The PRI MOS system used consists of an illumination unit and a recording unit. The illumination unit, with the aid of a digital micro-mirror projector, projects lines onto the surface. These projected parallel lines are diverted or modulated by the surface structure. The modulated lines are recorded using a CCD camera arranged at a defined angle, referred to as the triangulation angle.

Size of measuring field: 14.5×23.4 mm²

Profile length: 20.0 mm

Areal roughness: 1.0 mm from the edge (Xm=21.4 mm; Ym=12.5 mm)

Filtering: 3rd-order polynomial filter

The surface roughness Rₐ represents the average height of the roughness, more particularly the average absolute distance from the centre line (regression line) of the roughness profile within the region under evaluation. Expressed alternatively, Rₐ is the arithmetic mean roughness, i.e. the arithmetic mean value of all profile values of the roughness profile.

Corresponding instruments can be acquired from companies including GFMesstechnik GmbH of Teltow, Germany.

### Shrinkage

To determine the shrinkage of a liner under the conditions prevailing during the foaming of a self-adhesive composition layer in accordance with the method of the invention, test strips of the liner are stored at the foaming temperature and for the foaming time used in the method. Specimens employed here are typically a swatch or roll specimen of the liner. Ater the removal of the first three turns, test strips in original width and with a length of 15 cm each are taken from the roll under test. The test strips are then accommodated in free suspension (holder: paperclip) in the preheated air-circulation cabinet, for the intended time (foaming time) at the specified testing temperature (foaming temperature) and, after this exposure, are cooled. Before and after storage, the dimensions of the strips in longitudinal and transverse directions are ascertained. To determine the dimensions, a steel rule (0.5 mm divisions) is used in each case. The shrinkage (in longitudinal and transverse directions) is calculated in % relative to the original dimensions of the test strips. The mean of the individual results from the measurement of three test strips is calculated, in both longitudinal and transverse directions.

### Weight Loss

To determine the weight loss of a liner under the conditions of the kind prevailing during the foaming of a self-adhesive composition layer in accordance with the method of the invention, test strips of the liner are stored at the foaming temperature and for the foaming time employed in the method and are subsequently cooled. Before and after the storage, the weight of the test strip is ascertained. The weight loss in % is calculated by reference to the original weight. The mean value of the individual results from three measurements on different test strips is used.

1. Method for producing a layer of self-adhesive composition at least partially foamed with microballoons, said method comprising heat-treating a foamable layer of self-adhesive composition comprising expandable microballoons and disposed between
(i) two liners,
(ii) a liner and a carrier, or
(iii) a liner and a further layer of self-adhesive composition which (a) is not foamable or (b) is foamable and typically comprises expandable microballoons,
by suitable energy input at a temperature suitable for foaming for a period such that after subsequent cooling of the layer the desired degree of foaming is attained,
wherein
the two liners or the liner during the foaming remain or remains adhering substantially completely on the respective surface of the foamable layer of self-adhesive composition on which they or it are or is disposed.

2. Method according to claim 1,
wherein
the foamable layer of self-adhesive composition is disposed between (i) two liners, (ii) a liner and a carrier, or (iii) a liner and a further layer of self-adhesive composition, by application of a self-adhesive composition comprising expandable microballoons from a solution to a liner or carrier and drying thereof below the foaming temperature, and a liner, a carrier or a further layer of self-adhesive composition, optionally applied to a liner or carrier, is laminated onto that surface of the dried layer of self-adhesive composition that is opposite the liner or carrier.

3. Method according to claim 1,
wherein
the foamable layer of self-adhesive composition is disposed between (i) two liners, (ii) a liner and a carrier, or (iii) a liner and a further layer of self-adhesive composition, by (i) the two liners, (ii) the liner and the carrier, or (iii) the liner and the further layer of self-adhesive composition, typically applied to a liner or carrier, being laminated onto the foamable layer of self-adhesive composition.

4. Method according to claim 1,
wherein
the two liners independently of one another or the liner during foaming are or is weight-stable.

5. Method according to claim 1,
wherein
the shrinkage of the two liners independently of one another or of the liner during foaming both in transverse direction and in longitudinal direction is less than 2%.

6. Method according to claim 1,
wherein
the liners or the liner during foaming consistently adopt a flat lie.

7. Method according to claim 1,
wherein
the foamable layer of self-adhesive composition is fully foamed.

8. Method according to claim 1,
wherein
the degree of foaming is at least 20% and less than 100%.

9. Method according to claim 1,
wherein
the energy needed for foaming is transferred by convection, radiation, or by heat conduction to the assembly composed of foamable layer of self-adhesive composition, liner and optionally carrier and/or further layer of self-adhesive composition.

10. Method according to claim 9,
wherein
the energy needed for foaming is transferred to the assembly uniformly by heat conduction over the web width.

11. Method according to claim 9,
wherein
the assembly is foamed in a drying tunnel.

12. Method according to claim 10,
wherein
the temperature difference of the assembly over the web width is at most 5 K.

13. Method according to claim 1,
wherein
the two liners independently of one another or the liner are or is (a) polyester liner(s).

14. Method according to claim 13,
wherein
the two liners or the liner have or has a thickness of more than 12 μm and up to 200 μm.

15. Method according to claim 1,
wherein
the carrier is a stretchable film carrier.

16. Method according to claim 1,
wherein
the carrier is a non-stretchable film carrier.

17. Method according to claim 1,
wherein
the foamable layer of self-adhesive composition is based on a vinylaromatic block copolymer composition and/or an acrylate composition.

18. Method according to claim 1,
wherein
the assembly made up of foamable layer of self-adhesive composition, liner and optionally carrier and/or further layer of self-adhesive composition is a transfer tape, a single-sided adhesive tape or a double-sided, carrier-containing adhesive tape.

19. Method according to claim 1,
wherein
the at least partially foamed layer of self-adhesive composition has a surface roughness Rₐ of less than 3 μm.

20. Adhesive tape which comprises at least one layer of self-adhesive composition at least partially foamed with microballoons and obtained by a method according to claim 1.

21. Method comprising bonding a component with an adhesive tape according to claim 20.

22. Method according to claim 21, wherein the component is selected from rechargeable batteries, electronic devices, mobile devices, and mobile phones.
